(19) United States
(12) Patent Application Publication
(10) Pub. No.: US 2023/0024020 A1
(43) Pub. Date: Jan. 26, 2023

(54) ADAPTIVE LOOP FILTERING

(71) Applicant: Telefonaktiebolaget LM Ericsson (publ), Stockholm (SE)

(72) Inventors: Jacob STRÖM, Stockholm (SE); Zhi ZHANG, Solna (SE); Kenneth ANDERSSON, Gävle (SE)

(73) Assignee: Telefonaktiebolaget LM Ericsson (publ), Stockholm (SE)

(21) Appl. No.: 17/783,132

(22) PCT Filed: Nov. 16, 2020
(86) PCT No.: PCT/SE2020/051096

§ 371 Date: Jun. 7, 2022

Related U.S. Application Data
(60) Provisional application No. 62/945,489, filed on Dec. 9, 2019.

(51) Int. Cl. H04N 19/117; H04N 19/132; H04N 19/82

(52) U.S. Cl. CPC H04N 19/117; H04N 19/132; H04N 19/82

(57) ABSTRACT

A method for decoding an image is provided. The method includes obtaining a first sample value associated with the image. The method further includes employing an ALF to filter the first sample value, the ALF being operable to filter the first sample value using any set of N coefficient values in which each one of the N coefficient values is included in a set of M unique coefficient values, wherein N is greater than 1 and M is greater than or equal to N and further wherein i) the set of M unique coefficient values consists of the following unique values or consists of a subset of the following unique values: +/−0, 1, 2, 3, 4, 5, 6, 7, 8, 9, 10, 12, 14, 15, 16, 17, 18, 20, 24, 28, 30, 31, 32, 33, 34, 36, 40, 48, 56, 60, 62, 63, 64, 65, 66, 68, 72, 80, 96, 112, 120, 124, 126, 127, or 128 and ii) the set of M unique coefficient values includes at least one of the following values: +/−3, 5, 6, 7, 9, 10, 12, 14, 15, 17, 18, 20, 24, 28, 30, 31, 33, 34, 36, 40, 48, 56, 60, 62, 63, 65, 66, 68, 72, 80, 96, 112, 120, 124, 126, 127.

### TECHNICAL FIELD

This disclosure relates to video encoding and/or decoding.

### BACKGROUND

This disclosure relates to the encoding and/or decoding of an image or a video sequence. A video sequence consists of several images. When viewed on a screen, the image consists of pixels, each pixel having a red, green and blue (RGB) value. However, when encoding and decoding a video sequence, the image is often not represented using RGB values but typically using another color space, including but not limited to YCbCr, IC_{T}C_{P}, non-constant-luminance YCbCr, and constant luminance YCbCr. If we take the example of YCbCr, it is made up of three components: luma (Y) which roughly represents luminance, and chroma (Cb, and Cr), both of which represents chrominance. It is often the case that Y is of full resolution, whereas the two other components, Cb and Cr, are of a smaller resolution. A typical example is a high definition (HD) video sequence containing 1920×1080 RGB pixels, which is often represented with a 1920×1080-resolution Y component, a 960×540 Cb component and a 960×540 Cr component. The elements in the components are called samples. In the example given above, there are therefore 1920×1080 samples in the Y component, and hence a direct relationship between samples and pixels. Therefore, in this document, we sometimes use the term pixels and samples interchangeably. For the Cb and Cr components, there is no direct relationship between samples and pixels; a single Cb sample typically influences several pixels.

In the draft for the Versatile Video Coding (VVC) standard, which is developed by the Joint Video Experts Team (JVET), the decoding of an image can be thought of as carried out in two stages: (1) prediction decoding and (2) loop filtering. In the prediction decoding stage, the samples of the components (Y, Cb and Cr) are partitioned into rectangular blocks. As an example, one block may be of size 4×8 samples, whereas another block may be of size 64×64 samples. The decoder obtains instructions for how to do a prediction for each block, for instance to copy samples from a previously decoded image (an example of temporal prediction), or copy samples from already decoded parts of the current image (an example of intra prediction), or a combination thereof. To improve this prediction, the decoder may obtain a residual, often encoded using transform coding such as discrete sine transform (DST). This residual is added to the prediction, and the decoder can proceed to decode the subsequent block.

The output from the prediction decoding stage is the three components Y, Cb and Cr. However, it is possible to further improve the fidelity of these components, and this is done in the loop filtering stage. The loop filtering stage in the current draft of VVC consists of three sub-stages: (1) a deblocking filter stage, (2) a sample adaptive offset filter (SAO) sub-stage, and (3) an adaptive loop filter (ALF) sub-stage.

In the deblocking filter sub-stage, the decoder changes Y, Cb and Cr by smoothing edges near block boundaries when certain conditions are met. This increases perceptual quality (subjective quality) since the human visual system is very good at detecting regular edges such as block artifacts along block boundaries. In the SAO sub-stage, the decoder adds or subtracts a signaled value to samples that meet certain conditions, such as being in a certain value range (band offset SAO) or having a specific neighborhood (edge offset SAO). This can reduce ringing noise since such noise often aggregate in certain value ranges or in specific neighborhoods (e.g., in local maxima). In this document we will denote the reconstructed image component that are the result of this stage Y_SAO, Cb_SAO, Cr_SAO.

Embodiments of this disclosure relate to the third sub-stage (i.e., the ALF stage). The basic idea behind adaptive loop filtering is that the fidelity of the image components Y_SAO Cb_SAO and Cr_SAO can often be improved by filtering the image using a linear filter that is signaled from the encoder to the decoder. As an example, by solving a least-squares problem, the encoder can determine what coefficient values a linear filter should have in order to most efficiently lower the error between the reconstructed image components so far, Y_SAO, Cb_SAO, Cr_SAO, and the original image components Y_org, Cb_org and Cr_org. These coefficient values (or simply “coefficients” for short) can then be signaled from the encoder to the decoder. The decoder reconstructs the image as described above to get Y_SAO, Cb_SAO, and Cr_SAO, obtains the filter coefficients from the bit stream and then applies the filter to get the final output, which we will denote Y_ALF, Cb_ALF, Cr_ALF.

In VVC, the ALF is more advanced than this. To start with, it is observed that it is often advantageous to filter some samples with one set of coefficients, but avoid filtering other samples, or perhaps filter those other samples with another set of coefficients. To that end, VVC classifies every Y sample (i.e., every luma sample) into one of 25 classes. The class to which a sample belongs is decided based on the local neighborhood of that sample, specifically on the gradients of surrounding samples and the activity of surrounding samples. It is possible for the encoder to signal one set of coefficients for each of the 25 classes. The decoder will then first decide which class a sample belongs to, and then select the appropriate set of coefficients to filter the sample. However, signaling 25 sets of coefficients can be costly. Hence the VVC standard also allows that only a few of the 25 classes are filtered using unique sets of coefficients. The remaining classes may reuse a set of coefficients used in another class, or it may be determined that they should not be filtered at all.

Another way to reduce cost is to use what is called the fixed coefficient set. This is a set of 64 hard-coded filters (i.e., 64 groups of coefficient values) that are known to the decoder. It is possible for the encoder to signal the use of one of these fixed (i.e., hard-coded) filters to the decoder very inexpensively, since they are already known to the decoder. For example, the decoder stores a set of 16 different groups of N index values (e.g., N=25) and the encoder transmits an initial index value that points to one of the 16 groups of N index values, where each one of the index values included in the group of N index values is associated with a class and each one of the index values points to one of the 64 hard-coded filters. For example, the first of the N values in the group of index values points to the fixed filter that should be used for the first class, the second value points to the fixed filter that should be used for the second class, etc. Accordingly, the decoder obtains an index value for a particular filter based on the initial index value and the class. Although these filters are cheap, they may not match the desired filter perfectly and thus result in slightly worse quality. The 64 allowed fixed filter coefficient sets are listed in Table 4. For samples belonging to Cb or Cr, i.e., for chroma samples, no classification is used and the same set of coefficients is used for all samples.

Transmitting the filter coefficients is costly, and therefore the same coefficient value is used for two filter positions. For luma (samples in the Y-component), the coefficients are re-used in the way shown in FIG. 1.

Referring to FIG. 1, assume R(x,y) is the sample to be filtered, situated in the middle of FIG. 1. Then samples R(x,y−1) (the sample exactly above) and the sample R(x,y+1) (the sample exactly below) will be treated with the same coefficient C6. The filtered version of the sample in position (x,y), which we will denote R_{F}(x,y), is calculated with the help of the variable sum which is in turn calculated as shown in Table 1 below:

TABLE 1

| | |
|---|---|
| sum = C0 * [clip(s0,R(x,y − 3) − R(x,y)) + clip(s0,R(x,y + 3) − R(x,y))] + | |
| C1 * [clip(s1,R(x − 1,y − 2) − R(x,y)) + clip(s1,R(x + 1,y + 2) − R(x,y))] + | |
| C2 * [clip(s2,R(x,y − 2) − R(x,y)) + clip(s2,R(x,y − 2) − R(x,y))] + | |
| C3 * [clip(s3,R(x + 1,y + 2) − R(x,y))+ clip(s3,R(x − 1,y − 2) − R(x,y))]+ | |
| C4 * [clip(s4,R(x − 2,y − 1) − R(x,y))+ clip(s4,R(x + 2,y + 1) − R(x,y))]+ | |
| C5 * [clip(s5,R(x − 1,y − 1) − R(x,y))+ clip(s5,R(x + 1,y + 1) − R(x,y))]+ | (Eqn 1) |
| C6 * [clip(s6,R(x,y − 1) − R(x,y))+ clip(s6,R(x,y + 1) − R(x,y))] + | |
| C7 * [clip(s7,R(x + 1,y − 1) − R(x,y))+ clip(s7,R(x − 1,y + 1) − R(x,y))]+ | |
| C8 * [clip(s8,R(x + 2,y − 1) − R(x,y))+ clip(s8,R(x − 2,y + 1) − R(x,y))]+ | |
| C9 * [clip(s9,R(x − 3,y) − R(x,y)) + clip(s9,R(x + 3,y) − R(x,y))] + | |
| C10 * [clip(s10, R(x − 2,y) − R(x,y)) + clip(s10,R(x + 2,y) − R(x, y))] + | |
| C11 * [clip(s11, R(x − 1,y) − R(x,y)) + clip(s11,R(x + 1,y) − R(x, y))]. | |

Here the clip(m,x) operation simply makes sure that the magnitude of the value x never exceeds m:

$$clip ( m , x ) = \{ \begin{matrix}min ( x , m ) & if x \geq 0 \\ max ( x , - m ) & if x < 0\end{matrix} \qquad ( Eqn 2 )$$

The filtered value R_{F}(x,y) is finally calculated as:

R_{F}(x,y)=R(x,y)+((sum+64)>>7) (Eqn 3)

The magnitudes s0 through s11 are also be signaled from the encoder to the decoder. Note that coefficient C12 is not used in Equation 1 since the value clip(s12,R(x,y)−R(x,y)) is always zero.

### SUMMARY

Certain challenges currently exist. For example, as can be seen in Equation (Eqn) 1, there are 12 multiplications per sample necessary to calculate the sum value. In hardware, multiplications can be expensive, especially if they must be dimensioned for large values, and if they have to produce a result every clock cycle. The allowed range of values for the coefficients C0 through C11 is [−127,127], and the largest value for the clip parameters s0 through s11 is 1023, in a 10-bit implementation. The value that C0 is multiplied by is a sum of two clip outputs, and can therefore be at most 2046 and at smallest −2046. This means that a signed 12-bit number can hold this factor. This in turn means that an 8-bit×12-bit multiplier must be implemented. In a typical scenario, it is required to be able to filter one sample per clock. This would mean that twelve multipliers of this size must be implemented. This is quite big in terms of silicon surface area, and hence quite costly to implement.

FIG. 2 shows one way of implementing an 8-bit×12-bit multiplier in hardware. This particular multiplier calculates the multiplication of two positive numbers, but a multiplier capable of multiplying signed 8-bit×12-bit numbers is very similar. There are more efficient ways to implement multiplication than the shifted additions shown in FIG. 2. However, the implementation still gives a rough approximation of the hardware complexity that would be needed in order to implement this multiplication in one clock-cycle; about seven adders of a width between 13 and 20 bits. This is a large number given that the hardware needs to be replicated twelve times, once for each coefficient.

Accordingly, this disclosure proposes ways to lower the size of the silicon surface area needed to implement this in hardware. In one embodiment, the coefficients are constrained such that each coefficient is a sum of two power-of-two numbers. This means that every coefficient multiplication in the filter can be implemented using only one 13-bit wide addition, as well as some other logic that is roughly the size of one more addition.

In one aspect a method for decoding an image is provided. In one embodiment the method includes obtaining a set of sample values associated with the image, the set of sample values comprising a first sample value. The method also includes employing an adaptive loop filter (ALF) to filter the first sample value. The ALF is operable to filter the first sample value using any set of N coefficient values in which each one of the N coefficient values is included in a set of M unique coefficient values, wherein N is greater than 1 and M is greater than 1. The set of M unique coefficient values consists of the following unique values or consists of a subset of the following unique values: +/−0, 1, 2, 3, 4, 5, 6, 7, 8, 9, 10, 12, 14, 15, 16, 17, 18, 20, 24, 28, 30, 31, 32, 33, 34, 36, 40, 48, 56, 60, 62, 63, 64, 65, 66, 68, 72, 80, 96, 112, 120, 124, 126, 127, or 128, and the set of M unique coefficient values includes at least one of the following values: +/−3, 5, 6, 7, 9, 10, 12, 14, 15, 17, 18, 20, 24, 28, 30, 31, 33, 34, 36, 40, 48, 56, 60, 62, 63, 65, 66, 68, 72, 80, 96, 112, 120, 124, 126, or 127. Employing the ALF to filter the first sample value comprises the steps of: a) obtaining a first set of N coefficient values for use in filtering the first sample value and b) using the ALF to filter the first sample value using the obtained first set of N coefficient values and the set of sample values, thereby producing a first filtered sample value, and each coefficient value included in the obtained first set of N coefficient values is constrained such that the coefficient value must be equal to one of the values included in the set of M unique values.

In one embodiment the method includes obtaining a set of sample values associated with the image, the set of sample values comprising a first sample value, and also obtaining an index value that points to a particular coefficient value group included within a set of M predefined coefficient value groups (e.g., M=64). Each coefficient value group included in the set of predefined coefficient value groups consists of N coefficient values, N being greater than 1, and: i) for each coefficient value group included in the set of predefined coefficient value groups, each coefficient value included in the coefficient group is constrained such that the coefficient value must be equal to one of the following values: +/−0, 1, 2, 3, 4, 5, 6, 7, 8, 9, 10, 12, 14, 15, 16, 17, 18, 20, 24, 28, 30, 31, 32, 33, 34, 36, 40, 48, 56, 60, 62, 63, 64, 65, 66, 68, 72, 80, 96, 112, 120, 124, 126, 127, or 128 and ii) for at least one coefficient value group included in the set of predefined coefficient value groups, at least one of the coefficient values included in said at least one coefficient value group is equal to one of the following values: +/−3, 5, 6, 7, 9, 10, 12, 14, 15, 17, 18, 20, 24, 28, 30, 31, 33, 34, 36, 40, 48, 56, 60, 62, 63, 65, 66, 68, 72, 80, 96, 112, 120, 124, 126, or 127. The method also includes using the index value to select the particular coefficient value group from the set of predefined coefficient value groups and employing an adaptive loop filter (ALF) to filter the first sample value using the particular coefficient value group selected from the set of predefined coefficient value groups.

In another aspect a decoding apparatus is provided. The decoding apparatus is adapted to perform any one of the decoding methods disclosed herein. In some embodiments, the decoding apparatus includes processing circuitry and a memory, said memory containing instructions executable by said processing circuitry.

In another aspect there is provided a method performed by an encoder. The method includes the encoder selecting a set of coefficient values for use by a decoder in filtering a sample value, the selected set of coefficient values consisting of N coefficient values. Each one of the N coefficient values is included in a set of M unique coefficient values, wherein N is greater than 1 and M is greater than 1 and further wherein i) the set of M unique coefficient values consists of the following unique values or consists of a subset of the following unique values: +/−0, 1, 2, 3, 4, 5, 6, 7, 8, 9, 10, 12, 14, 15, 16, 17, 18, 20, 24, 28, 30, 31, 32, 33, 34, 36, 40, 48, 56, 60, 62, 63, 64, 65, 66, 68, 72, 80, 96, 112, 120, 124, 126, 127, or 128 and ii) the set of M unique coefficient values includes at least one of the following values: +/−3, 5, 6, 7, 9, 10, 12, 14, 15, 17, 18, 20, 24, 28, 30, 31, 33, 34, 36, 40, 48, 56, 60, 62, 63, 65, 66, 68, 72, 80, 96, 112, 120, 124, 126, or 127. And each coefficient value included in the set of N coefficient values is constrained such that the coefficient value must be equal to one of the values included in the set of M unique values. The method also includes the encoder providing to a decoder the N coefficient values or an initial index value for use by the encoder to determine the set of N coefficient values.

In another aspect an encoding apparatus is provided. The encoding apparatus is adapted to perform any one of the encoding methods disclosed herein. In some embodiments, the encoding apparatus includes processing circuitry and a memory, said memory containing instructions executable by said processing circuitry.

In another aspect there is provided a computer program comprising instructions which when executed by processing circuitry causes the processing circuitry to perform any of the method disclosed herein. In another aspect a carrier containing the computer program is provided, wherein the carrier is one of an electronic signal, an optical signal, a radio signal, and a computer readable storage medium.

### Advantages

As a rough estimate of the surface area needed to implement various functions, assume that we calculate the number of additions and multiply by the width of those additions. As can be seen in FIG. 2, four 13-bit adders, two 16-bit adders and one 20-bit adder are used to multiply the two numbers. This gives a surface cost of 13*4+2*16+20=104. In the proposed embodiment, only two 13-bit adders are used. This gives a surface cost of 2*13=23. Hence the cost in terms of surface has decreased by (104−23)/104=78%, a substantial reduction. Given that the multipliers in an ALF make up a major part of the surface area needed, this translates to a significant reduction in the surface area needed for implementing the entire ALF method. Not only can surface area be saved, but also there will be a saving in power consumption, which can increase the battery life of a hand-held device, because the operations that are carried out in the proposed embodiments are less complex than a multiplication, and hence consume less power.

### BRIEF DESCRIPTION OF THE DRAWINGS

The accompanying drawings, which are incorporated herein and form part of the specification, illustrate various embodiments.

FIG. 1 provides an illustration of coefficient reuse.

FIG. 2 shows one way of implementing an 8-bit×11-bit multiplier in hardware.

FIG. 3 illustrates a system comprising an encoder and a decoder.

FIG. 4 illustrates an example encoder.

FIG. 5 illustrates an example decoder.

FIG. 6 illustrates the set of allowed coefficient values according to an embodiment.

FIG. 7 illustrates the set of allowed coefficient values according to an embodiment.

FIGS. 8-14 illustrate circuits according to various embodiments.

FIG. 15A shows a frequency plot of different coefficient code values.

FIG. 15B shows a frequency distribution of coefficient 11.

FIG. 16 illustrates a circuit according to an embodiment.

FIG. 17 shows the values of coefficient C0, C1, C6 and C11 respectively

FIG. 18A is a flow chart illustrating a process according to an embodiment.

FIG. 18B is a flow chart illustrating a process according to an embodiment.

FIG. 19 is a block diagram of an apparatus according to one embodiment.

FIG. 20 is a flow chart illustrating a process according to an embodiment.

### DETAILED DESCRIPTION

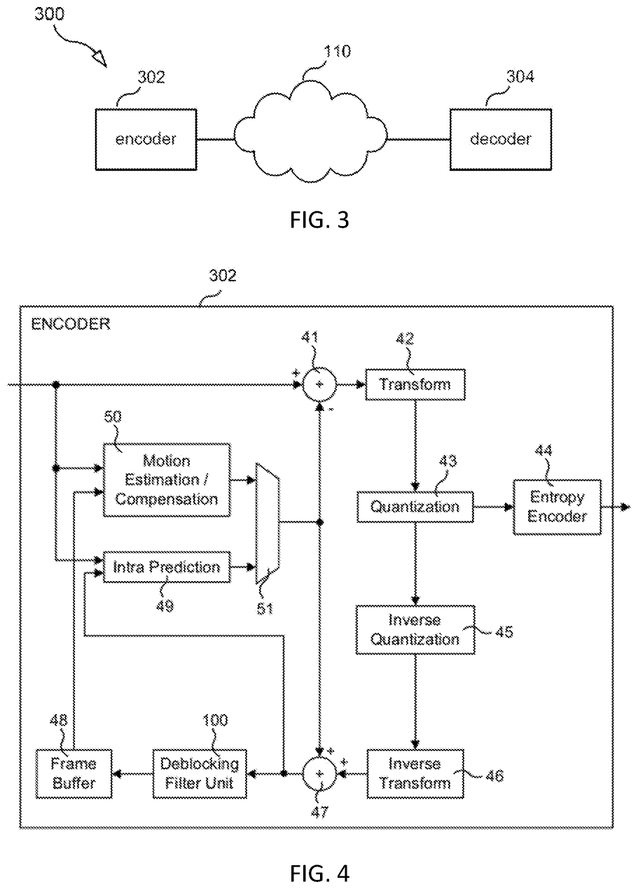

FIG. 3 illustrates a system 300 according to an example embodiment. System 300 includes an encoder 302 and a decoder 304. In the example shown, decoder 304 can receive via a network 110 (e.g., the Internet or other network) encoded images produced by encoder 302.

FIG. 4 is a schematic block diagram of encoder 302. As illustrated in FIG. 4, The encoder 302 takes in an original image and subtracts a prediction 41 that is selected 51 from either previously decoded samples (“Intra Prediction” 49) or samples from previously decoded frames stored in the frame buffer 48 through a method called motion compensation 50. The task of finding the best motion compensation samples is typically called motion estimation 50 and involves comparing against the original samples. After subtracting the prediction 41 the resulting difference is transformed 42 and subsequently quantized 43. The quantized results are entropy encoded 44 resulting in bits that can be stored, transmitted or further processed. The output from the quantization 43 is also inversely quantized 45 followed by an inverse transform 46. Then the prediction from 51 is added 47 and the result is forwarded to both the intra prediction unit 49 and to the Loopfilter Unit 100. The loopfilter unit 100 may do deblocking, SAO and/or ALF filtering. The result is stored in the frame buffer 48, which is used for future prediction. Not shown in the figure is that coding parameters for other blocks such as 42, 43, 49, 50, 51 and 100 also may also be entropy coded.

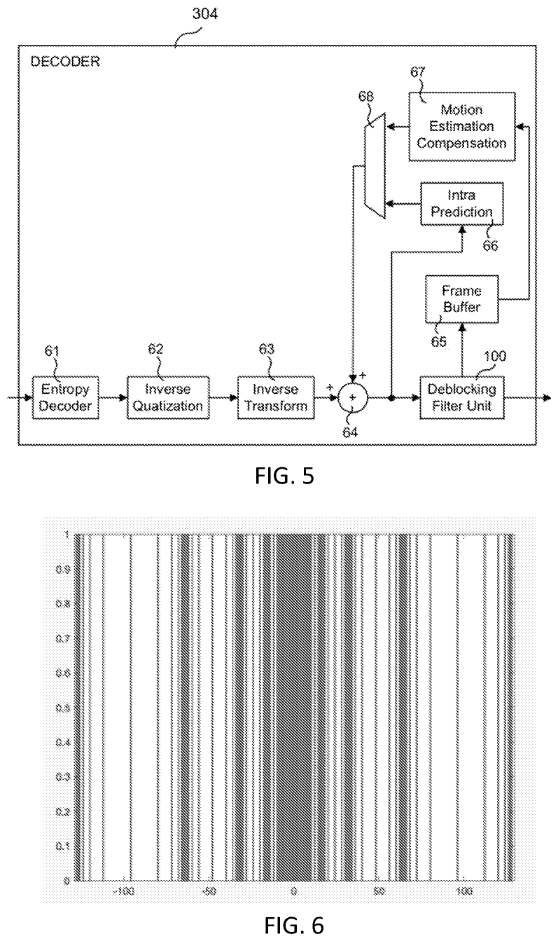

FIG. 5 is a corresponding schematic block diagram of decoder 304 according to some embodiments. The decoder 304 takes in entropy coded transform coefficients which are then decoded by decoder 61. The output of decoder 61 then undergoes inverse quantization 62 followed by inverse transform 63 to form a decoded residual. To this decoded residual, a prediction is added 64. The prediction is selected 68 from either a motion compensation unit 67 or from an intra prediction unit 66. After having added the prediction to the decoded residual 64, the samples can be forwarded for intra prediction of subsequent blocks. The samples are also forwarded to the loopfilter unit 100, which may do deblocking, SAO processing, and/or adaptive ALF processing. The output of the loopfilter unit 100 is forwarded to the frame buffer 65, which can be used for motion compensation prediction of subsequently decoded images 67. The output of the loopfilter unit 100 can also be output the decoded images for viewing or subsequent processing outside the decoder. Not shown in the figure is that parameters for other blocks such as 63, 67, 66 and 100 may also be entropy decoded. As an example, the coefficients for the ALF filter in block 100 may be entropy decoded.

In one embodiment, to achieve the advantages discussed above, the ALF part of the loopfilter unit 100 is configured such that the coefficients are restricted to certain values for which there is an inexpensive way to implement a multiplication. In one embodiment, the coefficients are restricted to pure powers-of-two, rather than allowing all values between −128 and 128. That is, the coefficients are constrained such that each coefficient must be equal to one of the following values: +/−{0, 1, 2, 4, 8, 16, 32, 64, 128}. Multiplication of a*b, where a is one of the allowed coefficient values, would then for positive values be implemented using b k, where k is 0 through 7. For negative values the result would have to be sign-corrected also. This would substantially reduce the complexity when implementing the multiplications, but it would come at a cost in precision. As it turns out, this means that the quality in terms of the average bit rate difference (BD-rate) can go down substantially, by as much as 0.2%. This is not a good trade-off between complexity and image quality.

Accordingly, in another embodiment it is proposed to use a less severe restriction on the allowable coefficient values. Instead of allowing all values between −128 and 128, only values that can be written as a pure power-of-two number or as the sum of two power-of-two numbers of arbitrary sign are allowed. As an example, 6 would be allowed, since it can be written as 4+2, and 7 would be allowed, since it can be written as 8-1, but 22 would not be allowed, since it cannot be written as either ±2ⁿ or (±2ⁿ±2^{m}). Also zero would be allowed since it can be written as, for instance 2\hat{ }1−2\hat{ }1.

The allowed coefficient values between −128 and 128 (excluding −128 and 128) are listed as set Z, Z={−127, −126, −124, −120, −112, −96, −80, −72, −68, −66, −65, −64, −63, −62, −60, −56, −48, −40, −36, −34, −33, −32, −31, −30, −28, −24, −20, −18, −17, −16, −15, −14, −12, −10, −9, −8, −7, −6, −5, −4, −3, −2, −1, 0, 1, 2, 3, 4, 5, 6, 7, 8, 9, 10, 12, 14, 15, 16, 17, 18, 20, 24, 28, 30, 31, 32, 33, 34, 36, 40, 48, 56, 60, 62, 63, 64, 65, 66, 68, 72, 80, 96, 112, 120, 124, 126, 127}.

In FIG. 6 we can see which numbers would be allowed in this case. As can be seen, most coefficients around zero would be allowed. For coefficients with larger magnitudes, more coefficients would be disallowed. This is reasonable, given the fact that the coefficients typically have a distribution where smaller coefficients are more common, i.e., similar to a Laplace distribution, and it is hence more important to be able to faithfully reproduce those. However, in the FIG. 6 it can also be seen that more values are allowed in some areas even though they have a high magnitude. As an example, around 64, most values are allowed, whereas around 48, very few are allowed. This does not make sense if the coefficients are really Laplace distributed; in that case a value around 48 is more probable than a value around 64. Therefore, in another embodiment the coefficients that can be used as ALF filter coefficients is further restricted.

That is, in one embodiment, a subset of Z is used, namely Z_{sub}. In one example Z_{sub}={−40, −33, −28, −24, −20, −17, −15, −14, −12, −10, −9, −8, −7, −6, −5, −4, −3, −2, −1, 0, 1, 2, 3, 4, 5, 6, 7, 8, 9, 10, 12, 14, 15, 17, 20, 24, 28, 33, 40}. In another embodiment, the coefficients are constrained so that the coefficients can must be written as either 0, ±2ⁿ or ±(2ⁿ+2ⁿ⁻¹) or ±(2ⁿ+2ⁿ⁻²). In another embodiment, the coefficients are constrained so that they can be written as either 0, ±2ⁿ or ±(2ⁿ+2ⁿ⁻¹). As can be seen in FIG. 7, much fewer coefficients are allowed in this last case. However, the distribution is better adapted to a Laplacian distribution, where the number of allowed coefficients decreases with magnitude.

The allowed values in this embodiment then belong to the following set S, S={−128, −96, −64, −48, −32, −24, −16, −12, −8, −6, −4, −3, −2, −1, 0, 1, 2, 3, 4, 6, 8, 12, 16, 24, 32, 48, 64, 96, 128}. The set of coefficients currently allowed in VVC is denoted herein as T, where T={−127, −126, −125, . . . −2, −1, 0, 1, 2, . . . , 125, 126, 127}.

To calculate the sum value from Equation 1 (see table 1), we need to perform several multiplications of the form a*b, where a is an allowed coefficient, i.e., it belongs to the set S, and b is a sum of two clipped difference value, i.e., it can take any value in the range [−2046,2046], needing a signed 12-bit variable to hold it.

We can write 2ⁿ+2ⁿ⁻¹ as 2ⁿ⁻¹(2+1)=2ⁿ⁻¹*3. Hence the value a is either 0, a pure power-of-two or a pure power-of-two multiplied by three. We can write this as:

a=±(k₁*2+k₀*1)*2^{s}, (Eqn. 4)

where k₀ and k₁ can take the values of 0 or 1.

In the case when we have a pure power-of-two, such as 128, we set k₁=1, k₀=0 and s to a suitable shift value, 6 in the case of 128. (Since k₁=1 we multiply by two, hence we should use 6 to represent 128.) In the case when we have a power-of-two number multiplied by three, such as 96, we set both k₁ and k₀ to 1, and use a suitable shift value, such as 5 in the case of 96. Table 2 shows possible values for k₁, k₀ and s for the values in S. It also shows the value n, which indicates if the value should be negated.

TABLE 2
How to write the allowed
coefficients on the form
(−1)ⁿ(2k₁ + k₀)2^{s}

| coefficient | k_1 | k_0 | s | n |
|---|---|---|---|---|
| −128 | 1 | 0 | 6 | 1 |
| −96 | 1 | 1 | 5 | 1 |
| −64 | 1 | 0 | 5 | 1 |
| −48 | 1 | 1 | 4 | 1 |
| −32 | 1 | 0 | 4 | 1 |
| −24 | 1 | 1 | 3 | 1 |
| −16 | 1 | 0 | 3 | 1 |
| −12 | 1 | 1 | 2 | 1 |
| −8 | 1 | 0 | 2 | 1 |
| −6 | 1 | 1 | 1 | 1 |
| −4 | 1 | 0 | 1 | 1 |
| −3 | 1 | 1 | 0 | 1 |
| −2 | 1 | 0 | 0 | 1 |
| −1 | 0 | 1 | 0 | 1 |
| 0 | 0 | 0 | 0 | 0 |
| 1 | 0 | 1 | 0 | 0 |
| 2 | 1 | 0 | 0 | 0 |
| 3 | 1 | 1 | 0 | 0 |
| 4 | 1 | 0 | 1 | 0 |
| 6 | 1 | 1 | 1 | 0 |
| 8 | 1 | 0 | 2 | 0 |
| 12 | 1 | 1 | 2 | 0 |
| 16 | 1 | 0 | 3 | 0 |
| 24 | 1 | 1 | 3 | 0 |
| 32 | 1 | 0 | 4 | 0 |
| 48 | 1 | 1 | 4 | 0 |
| 64 | 1 | 0 | 5 | 0 |
| 96 | 1 | 1 | 5 | 0 |
| 128 | 1 | 0 | 6 | 0 |

The decoder can use Table 2 to determine the values of k₁, k₀, s and n from the coefficient. An alternative is to use the following pseudo code for a coefficient coeff:

TABLE 3
k1 = (abs(coeff)<2 ? 0 : 1);
k0 = coeff & 1;
s = max(0, 6-clz(abs(coeff)));
n = sign(coeff);

Here abs(x) denotes absolute value of x, & denotes bitwise AND, max(a,b) returns the largest value of a and b, clz(x) counts the leading number of zeros in the binary representation of x, so the binary 8-bit number 0001111 (15 in decimal representation) will return 3, and sign(x) returns the sign of x. clz( ) is a common assembly instruction on most CPUs so it is inexpensive.

Note that this conversion only needs to happen when the coefficients are read from the Adaptive Parameter Set (APS). The APS consists of a set of parameters that the encoder transmits to the decoder. In particular, it contains the coefficient values used in ALF, and these are sent/received at most once per frame. Hence it is not critical that this conversion from coefficient to values is extremely fast or efficient. If, on the other hand, this conversion would have to happen every sample, it would be very important that it could be done quickly.

Once they have been converted, a hardware implementation can store them for later use during the filtering. Since of k₁, k₀, and n are 1-bit values, and s is a 3-bit value, the total number of bits that needs to be stored is 6 bits. This is less than the current implementation of ALF, which needs to store an 8-bit value between −127 and 127 for each coefficient.

The multiplication a*b can be re-written as:

$$a * b == {( - 1 )}^{n} ( 2 {k}_{1} + {k}_{0} ) {2}^{s} * b = \\ {( - 1 )}^{n} ( 2 * b * {k}_{1} + b * {k}_{0} ) {2}^{s} = {( - 1 )}^{n} ( ( ( b * {k}_{1} ) ≪ 1 ) + b * {k}_{0} ) {2}^{s} . \qquad ( Eqn 5 a )$$

To evaluate the bottom-most expression, we can start by multiplying b by Since k₁ is either 0 or 1 this is the same as doing AND between every bit in b and k₁. After this, we will shift it one step left. Likewise, we will do AND between b and k₀. We add these two results together, negate it if necessary and shift it 0 to 6 steps. Because the multiplications can be replaced by ANDs, Equation 5 can be written as:

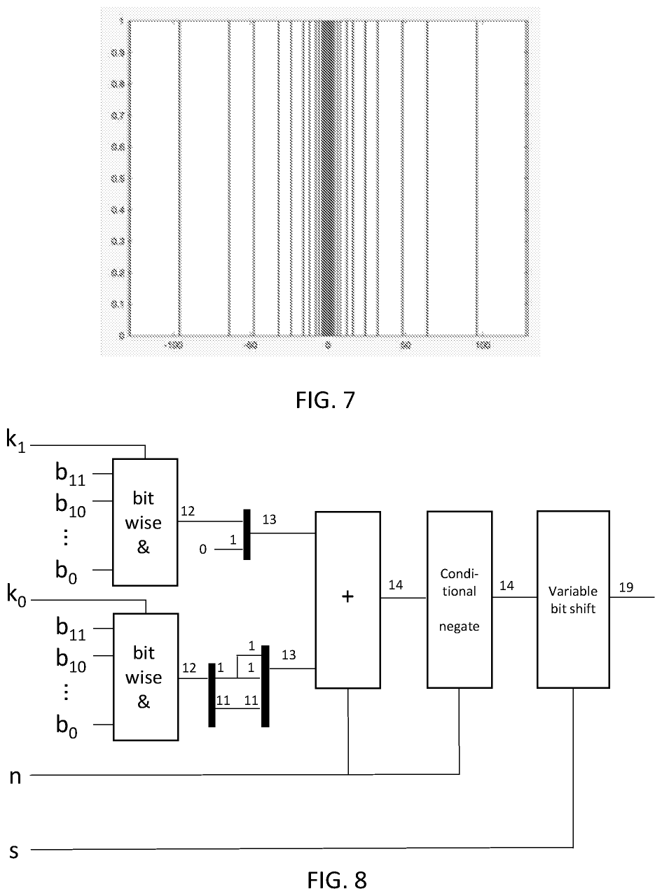

a*b=(−1)ⁿ(((b&_{b}k₁)<<1)+b&_{b}k₀)2^{s}, (Eqn 5b)

where x &_{b} y is used to denote that every bit in x is ANDed with the one-bit value y. Equation 5b can be efficiently implemented by the circuit shown in FIG. 8.

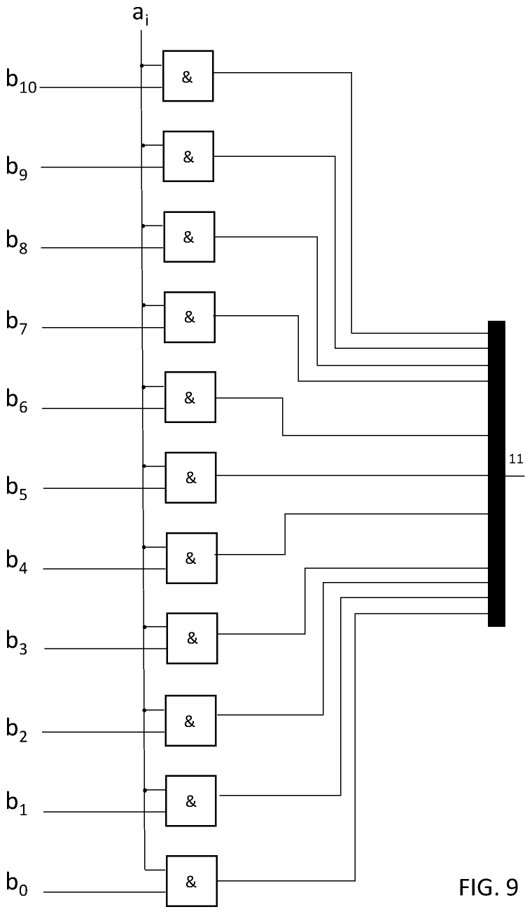

As can be seen in FIG. 8, the top left unit marked “bit-wise &” takes in the signed 12-bit number b=b₁₁b₁₀b₉b₈b₇b₆b₅b₄b₃b₂b₁b₀, where b₁₁ is the most significant bit, and does a bit-wise AND with k₁ according to outₖ=bₖ & k₁. Such a unit can be constructed using 12 AND-gates for 12-bit input data. FIG. 9 shows how such a unit capable of 11-bit input can be implemented in hardware using only 11 AND-gates, which are one of the least expensive computational units available in hardware. In FIG. 9 ai is fed with the input ki from FIG. 8. The output of the top left unit is shifted one bit, and a zero is inserted in the least significant bit position. This means that the resulting value is 13 bits.

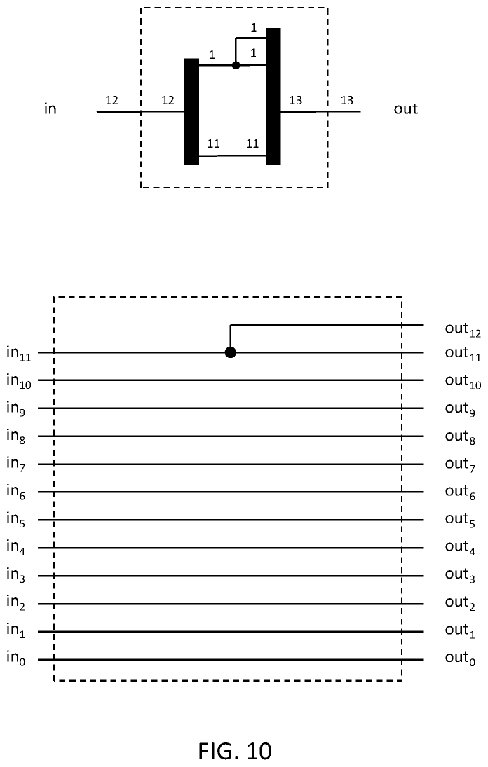

In a similar manner, the value b is bit-wise AND:ed with k₀ in the bottom-left unit marked “bit-wise &”. The output is not shifted, instead the sign bit is extended so that the result is also 13 bits. This is indicated by the wiring diagram between the lower “bit-wise &” unit and the adder. As can be seen in FIG. 10, this does not contain any logic. The top portion of FIG. 10 shows the wiring diagram from FIG. 8 and the bottom portion of FIG. 10 shows in further detail the same wiring, where the input bits are copied to the output, and the most significant bit in11 is copied to the two most significant bits in the output out12 and out11.

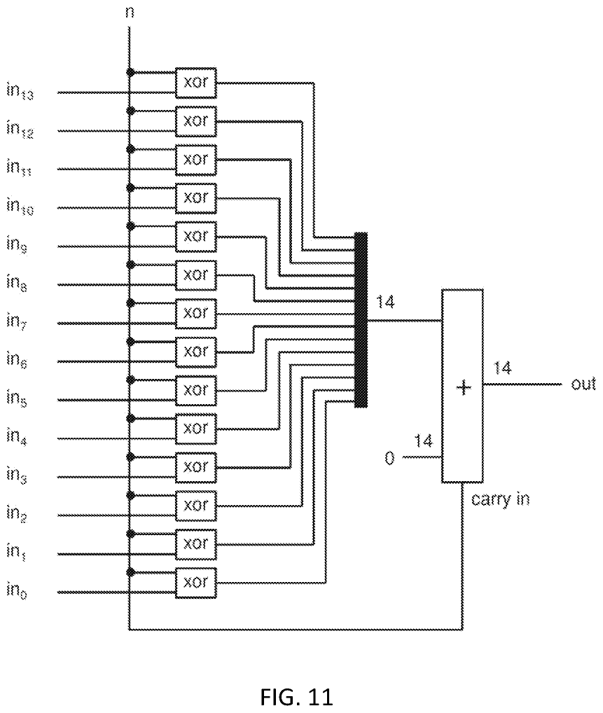

These 13-bit values are then added together using a 13-bit adder. The output is 14 bits, since one bit may carry. This result is then input to the unit marked “conditional negate”, which implements the multiplication of (−1)ⁿ. FIG. 11 shows how such a unit can be implemented in hardware. That is, FIG. 11 shows an example of how to implement a conditional negater. If the value n is 1, the input value is negated. If the value is 0, the input value is left untouched.

As is well-known for a person skilled in the art, it is possible to negate a value by inverting all the bits and adding 1. This should only be done in the case when n=1. By using an XOR gate, each input bit is inverted in the case when n=1, and left untouched when n=0. The result is then fed to an adder, where the other input is zero, and where the carry-in is set to n. This means that it will leave the value untouched if n=0, but if n=1 it will add 1. The result is a 14-bit value which is negated in relation to the input if n=1 and left untouched otherwise.

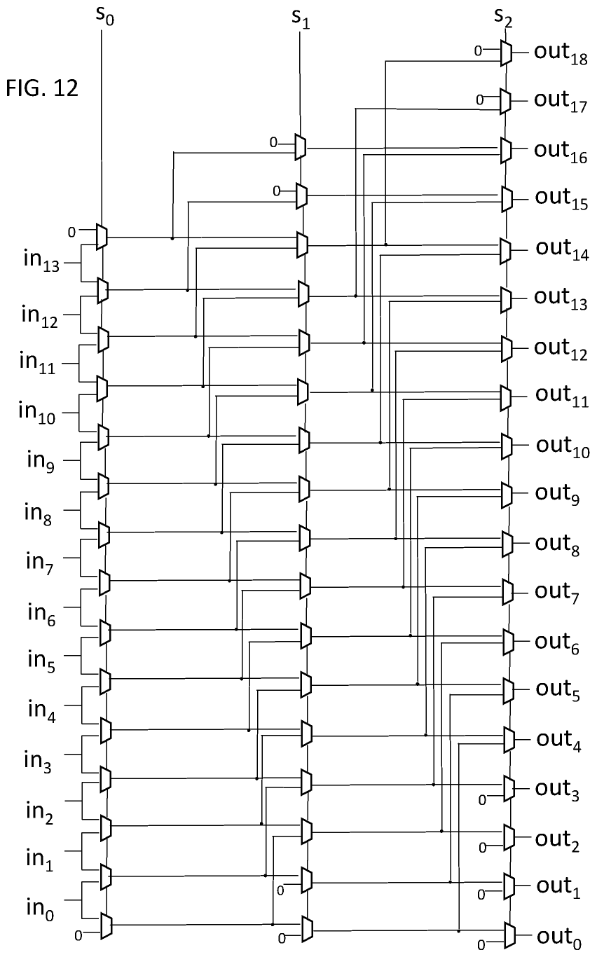

Finally, the right-most box in FIG. 8 marked “variable bit shift” implements the multiplication by 2^{s}. This can be efficiently implemented using a barrel shifter, as shown in FIG. 12, which illustrates a barrel-shifter, that shifts the input up to 6 steps to the left (up in this figure), controlled by the parameter s=s₂s₁s₀, where s₂ is the most-significant bit in s.

The barrel-shifter in FIG. 12 consists of 51 1-bit multiplexors, and although it may seem complex, it can be implemented very efficiently in hardware. The input to the barrel shifter is shifted s steps to the left, (up in FIG. 12) where the binary representation of s=s₂s₁s₀ and where s₂ is the most significant bit. Note that although the input is a signed 14-bit value, and the maximum shift is 6 steps, the output is a 19-bit value and not a 20-bit value. This is due to the fact that the values with largest magnitude to come out are −2046*128=−261888 and 2046*128=261888, both of which can be represented by a 19-bit number that can hold numbers in the range [−2¹⁸,2¹⁸−1]=[−262144,262143].

The FIGS. 9-12 are just examples of how to implement this type of multiplication. Often there are less expensive methods to implement the various building blocks in FIG. 8. As an example, FIG. 11 uses an adder where one of the inputs are set to zero. For a person skilled in the art, it is clear that this does not need to be implemented using a full general adder, but it is possible to reduce the size of this adder since we already know that one input will be zero.

In fact, it is possible to fully remove the conditional negater from FIG. 8. The result will then have the wrong sign, but this can be taken care of later when the value is added to another product to form the value ‘sum’ in Equation 1. In detail, consider the first two terms in the sum in Equation 1, rewritten here for convenience:

sum=C0*[clip(s0,R(x,y−3)−R(x,y))+clip(s0,R(x,y+3)−R(x,y))]+C1*[clip(s1,R(x−1,y−2)−R(x,y))+clip(s1,R(x+1,y+2)−R(x,y))]+ . . .

These two terms can be written as the addition of two products

partsum=a0*b0+a1*b1, (Eqn 6)

where a0=C0 which belongs to set S and where b0 is the value in the first square bracket. Likewise, a1=C1 and b1 is the value in the second square bracket. Assume we have calculated the correct value for a0*b0, but that we have the incorrect sign for the term a1*b1. We can then invert the bits in a1*b1 and use the carry-in in the adder to add one to the expression without paying the penalty of another adder. In detail, we use

partsum=a0*b0+bit_invert(a1*b1)+1, (Eqn 7)

where the 1 is added by setting carry-in to 1. If instead a0*b0 has the incorrect sign, but a1*b1 has the right sign, it is instead possible to use

partsum=bit_invert(a0*b0)+a1*b1+1, (Eqn 8)

where again the extra 1 is added using the carry in. If both values have the correct sign, we simply use

partsum=a0*b0+a1*b1. (Eqn 9).

However, if both terms have the incorrect sign, it is not possible to get the correct output. However, in that case it is still possible to get the negative of the correct output by using Equation 9. And since this output is in turn going to be added to further partial sums in Equation 1, it is possible to again avoid the extra adder. In the end one only needs a conditional negator for the value sum itself, which is much better than having a conditional negater for every multiplication in Equation 1, of which there are 12.

By removing the conditional negater from FIG. 8 in this way, the two most expensive operations that remain are the 13-bit adder and the barrel shift. Assuming that the barrel-shifter is approximately as complex as the adder, the cost of implementation is down to approximately two 13-bit adders.

### 0. Encoder-Only Embodiments

It is possible to have the encoder voluntarily restrict the coefficients to those in set S, i.e., values that are 0, ±1, ±2, ±3, ±4, ±6, ±8, ±12, ±16, ±24, ±32, ±48, ±64±96 or ±128. However, such a variant would not be compatible with the current VVC decoder, since values of ±128 are not allowed. Therefore, in one embodiment, it is possible for the encoder to voluntarily restrict the coefficients to an alternative set: S₉₆={0, +1, +2, +3, +4, +6, +8, +12, +16, +24, +32, +48, +64, +96}, i.e., S-{−128,128}. Therefore, in one embodiment, the encoder restricts the coefficients to those in set S₉₆, for instance by quantizing every coefficient to the nearest allowed coefficient, such as changing −34 to the allowed value −32.

However, for the decoder to be able to take advantage of the fact that the computation can be implemented less expensively, it has to be able to make sure that only values in S₉₆ are used for the coefficients. This can be done by checking during decoding; if all coefficients in all filters belong to S₉₆, then the less expensive (faster) implementation can be used. If there are one or more coefficients that do not belong to S₉₆, then the more expensive implementation is used. This solution has the advantage that the decoder does not need to be changed, since the expensive implementation (which is currently used) can always be used. For decoders that want to take advantage of the possibility of processing the data faster, or using less power, it can do so by checking the coefficients against S₉₆.

It should be noted that many of the 64 fixed filters that are currently defined have coefficients outside S₉₆, for instance the filter with index 0, see TABLE 4. Hence a decoder would also need to check that these are not used if the fast data processing should be used.

In one embodiment the encoder signals whether it uses coefficients in S₉₆ or if it allows all types of coefficients. In particular, it may also mean that the encoder guarantees that none of the 64 fixed filters that use coefficients outside S₉₆ are used. The decoder can then know which method to use without having to test every coefficient.

### 1. Embodiments that Change the Decoder Normatively

Using the fixed filters can be very effective, especially for low bit rates. Therefore it is a great handicap not to be able to use the 64 fixed filters. An alternative is therefore to change the fixed filters. This can be done by quantizing every filter coefficient to the nearest allowed coefficient. In Table 4 the fixed filters that are used in the current version of VVC are shown and Table 5 shows a quantized version that only uses values in S.

TABLE 4

| index | fixed coefficients in VVC |
|---|---|
| 0 | 0 0 2 −3 1 −4 1 7 −1 1 −1 5 |
| 1 | 0 0 0 0 0 −1 0 1 0 0 −1 2 |
| 2 | 0 0 0 0 0 0 0 1 0 0 0 0 |
| 3 | 0 0 0 0 0 0 0 0 0 0 −1 1 |
| 4 | 2 2 −7 −3 0 −5 13 22 12 −3 −3 17 |
| 5 | −1 0 6 −8 1 −5 1 23 0 2 −5 10 |
| 6 | 0 0 −1 −1 0 −1 2 1 0 0 −1 4 |
| 7 | 0 0 3 −11 1 0 −1 35 5 2 −9 9 |
| 8 | 0 0 8 −8 −2 −7 4 4 2 1 −1 25 |
| 9 | 0 0 1 −1 0 −3 1 3 −1 1 −1 3 |
| 10 | 0 0 3 −3 0 −6 5 −1 2 1 −4 21 |
| 11 | −7 1 5 4 −3 5 11 13 12 −8 11 12 |
| 12 | −5 −3 6 −2 −3 8 14 15 2 −7 11 16 |
| 13 | 2 −1 −6 −5 −2 −2 20 14 −4 0 −3 25 |
| 14 | 3 1 −8 −4 0 −8 22 5 −3 2 −10 29 |
| 15 | 2 1 −7 −1 2 −11 23 −5 0 2 −10 29 |
| 16 | −6 −3 8 9 −4 8 9 7 14 −2 8 9 |
| 17 | 2 1 −4 −7 0 −8 17 22 1 −1 −4 23 |
| 18 | 3 0 −5 −7 0 −7 15 18 −5 0 −5 27 |
| 19 | 2 0 0 −7 1 −10 13 13 −4 2 −7 24 |
| 20 | 3 3 −13 4 −2 −5 9 21 25 −2 −3 12 |
| 21 | −5 −2 7 −3 −7 9 8 9 16 −2 15 12 |
| 22 | 0 −1 0 −7 −5 4 11 11 8 −6 12 21 |
| 23 | 3 −2 −3 −8 −4 −1 16 15 −2 −3 3 26 |
| 24 | 2 1 −5 −4 −1 −8 16 4 −2 1 −7 33 |
| 25 | 2 1 −4 −2 1 −10 17 −2 0 2 −11 33 |
| 26 | 1 −2 7 −15 −16 10 8 8 20 11 14 11 |
| 27 | 2 2 3 −13 −13 4 8 12 2 −3 16 24 |
| 28 | 1 4 0 −7 −8 −4 9 9 −2 −2 8 29 |
| 29 | 1 1 2 −4 −1 −6 6 3 −1 −1 −3 30 |
| 30 | −7 3 2 10 −2 3 7 11 19 −7 8 10 |
| 31 | 0 −2 −5 −3 −2 4 20 15 −1 −3 −1 22 |
| 32 | 3 −1 −8 −4 −1 −4 22 8 −4 2 −8 28 |
| 33 | 0 3 −14 3 0 1 19 17 8 −3 −7 20 |
| 34 | 0 2 −1 −8 3 −6 5 21 1 1 −9 13 |
| 35 | −4 −2 8 20 −2 2 3 5 21 4 6 1 |
| 36 | 2 −2 −3 −9 −4 2 14 16 3 −6 8 24 |
| 37 | 2 1 5 −16 −7 2 3 11 15 −3 11 22 |
| 38 | 1 2 3 −11 −2 −5 4 8 9 −3 −2 26 |
| 39 | 0 −1 10 −9 −1 −8 2 3 4 0 0 29 |
| 40 | 1 2 0 −5 1 −9 9 3 0 1 −7 20 |
| 41 | −2 8 −6 −4 3 −9 −8 45 14 2 −13 7 |
| 42 | 1 −1 16 −19 −8 −4 −3 2 19 0 4 30 |
| 43 | 1 1 −3 0 2 −11 15 −5 1 2 −9 24 |
| 44 | 0 1 −2 0 1 −4 4 0 0 1 −4 7 |
| 45 | 0 1 2−5 1 −6 4 10 −2 1 −4 10 |
| 46 | 3 0 −3 −6 −2 −6 14 8 −1 −1 −3 31 |
| 47 | 0 1 0 −2 1 −6 5 1 0 1 −5 13 |
| 48 | 3 1 9 −19 −21 9 7 6 13 5 15 21 |
| 49 | 2 4 3 −12 −13 1 7 8 3 0 12 26 |
| 50 | 3 1 −8 −2 0 −6 18 2 −2 3 −10 23 |
| 51 | 1 1 −4 −1 1 −5 8 1 −1 2 −5 10 |
| 52 | 0 1 −1 0 0 −2 2 0 0 1 −2 3 |
| 53 | 1 1 −2 −7 1 −7 14 18 0 0 −7 21 |
| 54 | 0 1 0 −2 0 −7 8 1 −2 0 −3 24 |
| 55 | 0 1 1 −2 2 −10 10 0 −2 1 −7 23 |
| 56 | 0 2 2 −11 2 −4 −3 39 7 1 −10 9 |
| 57 | 1 0 13 −16 −5 −6 −1 8 6 0 6 29 |
| 58 | 1 3 1 −6 −4 −7 9 6 −3 −2 3 33 |
| 59 | 4 0 −17 −1 −1 5 26 8 −2 3 −15 30 |
| 60 | 0 1 −2 0 2 −8 12 −6 1 1 −6 16 |
| 61 | 0 0 0 −1 1 −4 4 0 0 0 −3 11 |
| 62 | 0 1 2 −8 2 −6 5 15 0 2 −7 9 |
| 63 | 1 −1 12 −15 −7 −2 3 6 6 −1 7 30 |

TABLE 5

| index | proposed fixed coefficients |
|---|---|
| 0 | 0 0 2 −3 1 −4 1 6 −1 1 −1 4 |
| 1 | 0 0 0 0 0 −1 0 1 0 0 −1 2 |
| 2 | 0 0 0 0 0 0 0 1 0 0 0 0 |
| 3 | 0 0 0 0 0 0 0 0 0 0 −1 1 |
| 4 | 2 2 −6 −3 0 −4 12 24 12 −3 −3 16 |
| 5 | −1 0 6 −8 1 −4 1 24 0 2 −4 8 |
| 6 | 0 0 −1 −1 0 −1 2 1 0 0 −1 4 |
| 7 | 0 0 3 −12 1 0 −1 32 4 2 −8 8 |
| 8 | 0 0 8 −8 −2 −6 4 4 2 1 −1 24 |
| 9 | 0 0 1−1 0 −3 1 3 −1 1 −1 3 |
| 10 | 0 0 3 −3 0 −6 4 −1 2 1 −4 24 |
| 11 | −6 1 4 4 −3 4 12 12 12 −8 12 12 |
| 12 | −4 −3 6 −2 −3 8 12 16 2 −6 12 16 |
| 13 | 2 −1 −6 −4 −2 −2 16 12 −4 0 −3 24 |
| 14 | 3 1 −8 −4 0 −8 24 4 −3 2 −8 32 |
| 15 | 2 1 −6 −1 2 −12 24 −4 0 2 −8 32 |
| 16 | −6 −3 8 8 −4 8 8 6 12 −2 8 8 |
| 17 | 2 1 −4 −6 0 −8 16 24 1 −1 −4 24 |
| 18 | 3 0 −4 −6 0 −6 16 16 −4 0 −4 24 |
| 19 | 2 0 0 −6 1 −8 12 12 −4 2 −6 24 |
| 20 | 3 3 −12 4 −2 −4 8 24 24 −2 −3 12 |
| 21 | −4 −2 6 −3 −6 8 8 8 16 −2 16 12 |
| 22 | 0 −1 0 −6 −4 4 12 12 8 −6 12 24 |
| 23 | 3 −2 −3 −8 −4 −1 16 16 −2 −3 3 24 |
| 24 | 2 1 −4 −4 −1 −8 16 4 −2 1 −6 32 |
| 25 | 2 1 −4 −2 1 −8 16 −2 0 2 −12 32 |
| 26 | 1 −2 6 −16 −16 8 8 8 16 12 12 12 |
| 27 | 2 2 3 −12 −12 4 8 12 2 −3 16 24 |
| 28 | 1 4 0 −6 −8 −4 8 8 −2 −2 8 32 |
| 29 | 1 1 2 −4 −1 −6 6 3 −1 −1 −3 32 |
| 30 | −6 3 2 8 −2 3 6 12 16 −6 8 8 |
| 31 | 0 −2 −4 −3 −2 4 16 16 −1 −3 −1 24 |
| 32 | 3 −1 −8 −4 −1 −4 24 8 −4 2 −8 24 |
| 33 | 0 3 −12 3 0 1 16 16 8 −3 −6 16 |
| 34 | 0 2 −1 −8 3 −6 4 24 1 1 −8 12 |
| 35 | −4 −2 8 16 −2 2 3 4 24 4 6 1 |
| 36 | 2 −2 −3 −8 −4 2 12 16 3 −6 8 24 |
| 37 | 2 1 4 −16 −6 2 3 12 16 −3 12 24 |
| 38 | 1 2 3 −12 −2 −4 4 8 8 −3 −2 24 |
| 39 | 0 −1 8 −8 −1 −8 2 3 4 0 0 32 |
| 40 | 1 2 0 −4 1 −8 8 3 0 1 −6 16 |
| 41 | −2 8 −6 −4 3 −8 −8 48 12 2 −12 6 |
| 42 | 1 −1 16 −16 −8 −4 −3 2 16 0 4 32 |
| 43 | 1 1 −3 0 2 −12 16 −4 1 2 −8 24 |
| 44 | 0 1 −2 0 1 −4 4 0 0 1 −4 6 |
| 45 | 0 1 2 −4 1 −6 4 8 −2 1 −4 8 |
| 46 | 3 0 −3 −6 −2 −6 12 8 −1 −1 −3 32 |
| 47 | 0 1 0 −2 1 −6 4 1 0 1 −4 12 |
| 48 | 3 1 8 −16 −24 8 6 6 12 4 16 24 |
| 49 | 2 4 3 −12 −12 1 6 8 3 0 12 24 |
| 50 | 3 1 −8 −2 0 −6 16 2 −2 3 −8 24 |
| 51 | 1 1 −4 −1 1 −4 8 1 −1 2 −4 8 |
| 52 | 0 1 −1 0 0 −2 2 0 0 1 −2 3 |
| 53 | 1 1 −2 −6 1 −6 12 16 0 0 −6 24 |
| 54 | 0 1 0 −2 0 −6 8 1 −2 0 −3 24 |
| 55 | 0 1 1 −2 2 −8 8 0 −2 1 −6 24 |
| 56 | 0 2 2 −12 2 −4 −3 32 6 1 −8 8 |
| 57 | 1 0 12 −16 −4 −6 −1 8 6 0 6 32 |
| 58 | 1 3 1 −6 −4 −6 8 6 −3 −2 3 32 |
| 59 | 4 0 −16 −1 −1 4 24 8 −2 3 −16 32 |
| 60 | 0 1 −2 0 2 −8 12 −6 1 1 −6 16 |
| 61 | 0 0 0 −1 1 −4 4 0 0 0 −3 12 |
| 62 | 0 1 2 −8 2 −6 4 16 0 2 −6 8 |
| 63 | 1 −1 12 −16 −6 −2 3 6 6 −1 6 32 |

Note that if one uses a representation where the fixed coefficients have already been converted to k₁, k₀, s and n, one can store the entire Table 5 using 6 bits per coefficients. Since the largest magnitude is 45, a 7-bit number (capable of holding values in the range [−64, 63]) would otherwise be needed. Hence one bit per stored value can be saved this way.

An alternative to using S₉₆ and S is to use S₁₂₇={0, +1, +2, +3, +4, +6, +8, +12, +16, +24, +32, +48, +64, +96, +127}. S₁₂₇ is similar to S but uses ±127 instead of ±128. This, however, would make a hardware implementation more difficult because it would have to be able to handle multiplication a*b where a=127, which can be done relatively cheaply using (b<<7)−b. This could be added as a step after FIG. 8. This embodiment has been tested under the common test conditions (CTC) for VTM 6.0, the reference software for VVC version 6. The decoder was changed only by changing the fixed coefficients according to Table 5. The encoder was changed so that it quantized every coefficient to the nearest one in S₁₂₇. The result was an increase in average bit rate difference (BD-rate) of about 0.1%, meaning that for the same quality, the bit rate increased 0.1%. The exact numbers for the different configurations were

+0.09% (all intra) +0.10% (random access) +0.07% (low-delay B) +0.15% (low-delay P).

Although 0.1% may not seem as a big increase in bit rate, it would be better to have a smaller BD-rate penalty for the simplification. There are much fewer coefficients in S, S₉₆ and S₁₂₇ than in the currently allowed coefficient set T that includes every number between −127 and 127. Since the number of allowed coefficients differs so much, it makes sense to code them differently in the case of S and T. However, that means that the decoder must be changed in a normative way. This may be advantageous from another perspective as well: in the encoder-only implementations, the decoder always has to be able to fall back to a solution that can handle all types of coefficients if the encoder has not constrained the coefficients. This means that we need two implementations: one for non-restricted coefficients (set T) and one for the restricted coefficients (e.g., S, S₉₆ or S₁₂₇ dependent on implementation). Hence in hardware one would have to implement more hardware than if only restricted coefficients were used. In summary, an encoder-only solution might not provide many benefits.

1.1 More Efficient Coefficient Encoding

In one embodiment, the encoder is forced to always restrict the coefficients, for instance to S. This way, a hardware implementation can lower the complexity by implementing only the solution described in FIGS. 8-12. Likewise, a software implementation can gain speed if the software architecture is one where this is possible.

Since the decoder has to be changed anyway, it is possible to use a different encoding of the coefficients than is used in the current VVC draft. Currently, the magnitude abs(coeff) is first coded using 3-Exponential-Golumb coding as shown in Table 6.

TABLE 6

| | magnitude | |
|---|---|---|
| magnitude | bits | sign bit |
| 0 | 1000 | |
| 1 | 1001 | 0/1 |
| 2 | 1010 | 0/1 |
| 3 | 1011 | 0/1 |
| 4 | 1100 | 0/1 |
| 5 | 1101 | 0/1 |
| 6 | 1110 | 0/1 |
| 7 | 1111 | 0/1 |
| 8 | 010000 | 0/1 |
| 9 | 010001 | 0/1 |
| 10 | 010010 | 0/1 |
| 11 | 010011 | 0/1 |
| 12 | 010100 | 0/1 |
| 13 | 010101 | 0/1 |
| 14 | 010110 | 0/1 |
| 15 | 010111 | 0/1 |
| 16 | 011000 | 0/1 |
| 17 | 011001 | 0/1 |
| 18 | 011010 | 0/1 |
| 19 | 011011 | 0/1 |
| 20 | 011100 | 0/1 |
| 21 | 011101 | 0/1 |
| 22 | 011110 | 0/1 |
| 23 | 011111 | 0/1 |
| 24 | 00100000 | 0/1 |
| . . . | . . . | . . . |

Apart from the magnitude, the sign will also be encoded/decoded for all values except 0. This means that 0 is represented by four bits, ±1, ±2, ±3, ±4, ±5, ±6 and ±7 are represented by five bits, values from ±8 through ±24 are represented by seven bits, etc.

Since we do not need to represent most of these values when we restrict the coefficients to the set S, in one embodiment we instead use the truncated binary coding to code the index of the coefficients magnitude according to Table 7:

TABLE 7

| magnitude | index | index bits | sign bit |
|---|---|---|---|
| 0 | 0 | 000 | |
| 1 | 1 | 0010 | 0/1 |
| 2 | 2 | 0011 | 0/1 |
| 3 | 3 | 0100 | 0/1 |
| 4 | 4 | 0101 | 0/1 |
| 6 | 5 | 0110 | 0/1 |
| 8 | 6 | 0111 | 0/1 |
| 12 | 7 | 1000 | 0/1 |
| 16 | 8 | 1001 | 0/1 |
| 24 | 9 | 1010 | 0/1 |
| 32 | 10 | 1011 | 0/1 |
| 48 | 11 | 1100 | 0/1 |
| 64 | 12 | 1101 | 0/1 |
| 96 | 13 | 1110 | 0/1 |
| 128 | 14 | 1111 | 0/1 |

By comparing Table 6 with Table 7, we see that the encoding in Table 7 always uses the same number of bits or fewer bits. Hence, we will always save bits if encoding and decoding according to Table 7. This also turns out to be the case in practice; when testing on the CTC for VTM6.0 we get the following BD-rate numbers: +0.03% (all intra)+0.04% (random access)+0.00% (low-delay B)+0.02% (low-delay P). Thus most of the penalty is gone.

1.2 Further Reducing the Allowed Set of Coefficients

When analyzing the bit streams obtained in the previous test, it is clear that the two largest magnitudes, 96 and 128, are very rarely used. Therefore, in an alternative embodiment, a further restriction is used, allowing only coefficients in the following set: S64={−64, −48, −32, −24, −16, −12, −8, −6, −4, −3, −2, −1, 0, 1, 2, 3, 4, 6, 8, 12, 16, 24, 32, 48, 64}. Since there are now fewer magnitudes, it is possible to reduce the number of bits for the smallest magnitudes, as is shown in Table 8.

TABLE 8

| magnitude | index | index bits | sign bit |
|---|---|---|---|
| 0 | 0 | 000 | |
| 1 | 1 | 001 | 0/1 |
| 2 | 2 | 010 | 0/1 |
| 3 | 3 | 0110 | 0/1 |
| 4 | 4 | 0111 | 0/1 |
| 6 | 5 | 1000 | 0/1 |
| 8 | 6 | 1001 | 0/1 |
| 12 | 7 | 1010 | 0/1 |
| 16 | 8 | 1011 | 0/1 |
| 24 | 9 | 1100 | 0/1 |
| 32 | 10 | 1101 | 0/1 |
| 48 | 11 | 1110 | 0/1 |
| 64 | 12 | 1111 | 0/1 |

Table 8 shows that in one embodiment magnitudes 96 and 128 are not allowed. This makes it possible to use shorter codes for magnitude 0, 1, and 2.

Trying this version on the CTC for VTM7.0 gives the following BD-rate figures: +0.02% (all intra) +0.03% (random access). Thus the penalty for quantizing coefficients has been further reduced in terms of BD-rate.

Obtaining the values for the variables k₀, k₁, n and s can be done using the C-like pseudo-code in Table 9.

TABLE 9

char s_from_index[7] = {0, 0, 1, 2, 3, 4, 5};
xReadTruncBinCode(index, 13); //read index
if(index==0)
READ_FLAG( n, “variable n”);
s = s_from_index[index>>1];
k1 = (index < 2 ? 0 : 1);
k0 = index % 1;

As an example, the xReadTruncBinCode( ) function reads the bits 1010 which, according to Table 8 gives an index of 7. (This, according to Table 8, is indicative of a magnitude of 12.) Hence the value 7 is put into the index variable. Since index is not 0, the code proceeds to read one bit using READ_FLAG(n, “variable n”) and puts the result in n. Assume it gets n=1. That indicates that the sign is negative. The coefficient to use is thus −12. The shift value s used is found in the array s_from_index, specifically by using the 7>>1=3 as index to the array. This means that s will become 2. Next, since index>2, k1 will be 1. Finally, k0 will be set to 7% 1 which equals 1. We thus have finished decoding the necessary values n=1, s=2, k0=1 and k1=1. We can now double-check with Equation 5a that this indeed gives the correct coefficient value −12: coeff=(−1)ⁿ(2k₁+2S=(−1)¹(2*1+1)*2²=(−1)*3*4=−12.

1.3a Using Signed Truncated Coding for the Coefficients

In another embodiment it is possible to use signed truncated coding for the coefficients. Table 10A shows how the coefficients may be coded in such an embodiment.

TABLE 10A

| bit | | signed | |
|---|---|---|---|
| representation | index | value | coefficient |
| 0000 | 0 | 0 | 0 |
| 0001 | 1 | −1 | −1 |
| 0010 | 2 | 1 | 1 |
| 0011 | 3 | −2 | −2 |
| 0100 | 4 | 2 | 2 |
| 0101 | 5 | −3 | −3 |
| 0110 | 6 | 3 | 3 |
| 01110 | 7 | −4 | −4 |
| 01111 | 8 | 4 | 4 |
| 10000 | 9 | −5 | −6 |
| 10001 | 10 | 5 | 6 |
| 10010 | 11 | −6 | −8 |
| 10011 | 12 | 6 | 8 |
| 10100 | 13 | −7 | −12 |
| 10101 | 14 | 7 | 12 |
| 10110 | 15 | −8 | −16 |
| 10111 | 16 | 8 | 16 |
| 11000 | 17 | −9 | −24 |
| 11001 | 18 | 9 | 24 |
| 11010 | 19 | −10 | −32 |
| 11011 | 20 | 10 | 32 |
| 11100 | 21 | −11 | −48 |
| 11101 | 22 | 11 | 48 |
| 11110 | 23 | −12 | −64 |
| 11111 | 24 | 12 | 64 |

The coefficients could be recovered using the following pseudo-code:

TABLE 11A

char magtab[13] = {0, 1, 2, 3, 4, 6, 8, 12, 16, 24, 32, 48, 64};
xReadTruncBinCode(index, 25); // read index
sign = (−1) * (index & 1);
magnitude = (index+1) >> 1;
coefficient = sign*magtab [magnitude];

1.3b Using Fixed Length Coding for the Coefficients

In another embodiment it is possible to use fixed length coding for the coefficients. Table 10B shows how the coefficients may be coded in such an embodiment.

TABLE 10B

| magnitude | index | index bits | sign bit |
|---|---|---|---|
| 0 | 0 | 0000 | |
| 1 | 1 | 0001 | 0/1 |
| 2 | 2 | 0010 | 0/1 |
| 3 | 3 | 0011 | 0/1 |
| 4 | 4 | 0100 | 0/1 |
| 6 | 5 | 0101 | 0/1 |
| 8 | 6 | 0110 | 0/1 |
| 12 | 7 | 0111 | 0/1 |
| 16 | 8 | 1000 | 0/1 |
| 24 | 9 | 1001 | 0/1 |
| 32 | 10 | 1010 | 0/1 |
| 48 | 11 | 1011 | 0/1 |
| 64 | 12 | 1100 | 0/1 |
| 96 | 13 | 1101 | 0/1 |

The coefficients could be recovered using the following pseudo-code:

TABLE 11B
char s_from_index[7] = {0, 0, 1, 2, 3, 4, 5};
xReadFixedLength(index, 4); // read 4 bits
if(index==0)
READ_FLAG( n, “variable n”);
s = s_from_index[index>>1];
k1 = (index < 2 ? 0 : 1);
k0 = index % 1;

Since there are two more possible codewords (1110 and 1111) it would be possible to also accommodate a magnitude of 128 and even 192. It is also possible to restrict the coding so that 64 becomes the largest magnitude.

Alternatively, the variables k₀, k₁, n and s can be directly recovered from the index using the following pseudo code:

TABLE 12
char s_from_index[7] = {0, 0, 1, 2, 3, 4, 5};
xReadTruncBinCode(index, 25); // read index
n = (index & 1);
s = s_from_index[index>>2];
k1 = (index < 3 ? 0 : 1);
k0 = ((index+1)>>1) % 1;

1.4 Allowing Power-of-Two Multiples of 0, 1, 3 and 5.

In some circumstances it may be limiting to constrain the coefficients to only be of the form ±{0,1,3}×2ⁿ. Most coefficients are close to zero, which means that it is most important to be able to represent coefficients close to zero, such as {0, +1, +2, +3, +4, +5, +6, +7, +8, +9, +10}. Out of these only {0, +1, +2, +3, +4, +6, +8} are possible to represent on the form ±{0,1,3}×2ⁿ. However, if we also allow 5×2ⁿ, we can also represent ±5 and ±10. As it turns out, it is not much more expensive to create hardware that allows for ±{0,1,3,5}×2ⁿ than it is to create hardware that allows for ±{0,1,3}×2ⁿ. The reason for this is that, just as for the factor 3, multiplying a number by 5 can also be implemented using a single addition and shifts, since 5x=4x+x=(x<<2)+x.

In general, we can modify Equation 5b so that we will be able to incorporate also a multiplication a*b when a=5:

a*b=(−1)ⁿ(((b&_{b}k₁)<<s₀)+b&_{b}k_{b})2^{s}^{₁} (Eqn 9b)

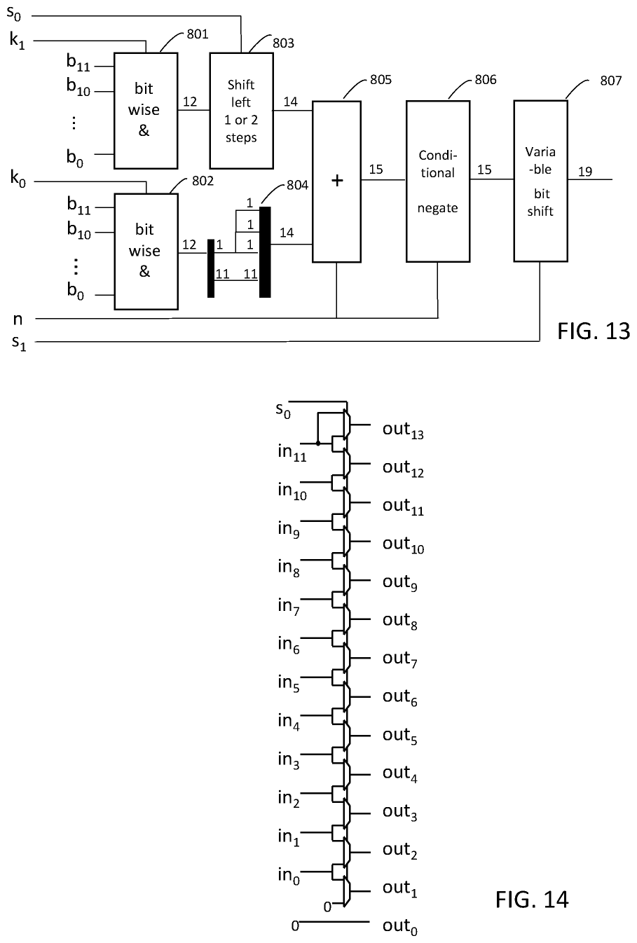

The difference compared to Equation 5 is that, instead of always shifting 1 step, we now shift 1 or 2 steps, controlled by the variable s₀. Another change compared to Equation 5 is that the variable s has changed name to s₁. FIG. 13 shows how such a hardware implementation can be constructed.

When comparing the diagram in FIG. 13 to the one in FIG. 8 we see that the major difference is the box marked 803. This now shifts the value b &_{b} k₁ left either one or two steps, whereas in FIG. 8 it always shifts left one step. This means that both 3*b=(b<<1)+b and 5*b=(b<<2)+b can be constructed as output of the adder 805. This shift is controlled by the shift value s₀, which shifts 1 step if s₀=0 and two steps if s₀=1. The box 803 can be implemented inexpensively using 13 1-bit muxes as shown in FIG. 14.

The other difference against FIG. 8 is that the output of 802 is now sign-extended two bits to go from a signed 12-bit number to a signed 14-bit number using the wiring marked with 804. It is now possible to use a coefficient set such as S₁₃₅=+{0, 1, 2, 3, 4, 5, 6, 8, 10, 12, 16, 20, 24, 32, 40, 48, 64}.

Table 13 shows what values to set for k₁, k₂, s₀ and s₁ to obtain the positive coefficients in S₁₃₅. (The value n is 0 for the positive coefficients.) The values for k₁, k₂, s₀ and s₁ for the negative coefficients are the same as for the positive coefficients, but n=1.

TABLE 13

| coefficient | k_1 | k_0 | s_0 | s_1 |
|---|---|---|---|---|
| 0 | 0 | 0 | 0 | 0 |
| 1 | 0 | 1 | 0 | 0 |
| 2 | 1 | 0 | 0 | 0 |
| 3 | 1 | 1 | 0 | 0 |
| 4 | 1 | 0 | 0 | 1 |
| 5 | 1 | 1 | 1 | 0 |
| 6 | 1 | 1 | 0 | 1 |
| 8 | 1 | 0 | 0 | 2 |
| 10 | 1 | 1 | 1 | 1 |
| 12 | 1 | 1 | 0 | 2 |
| 16 | 1 | 0 | 0 | 3 |
| 20 | 1 | 1 | 1 | 2 |
| 24 | 1 | 1 | 0 | 3 |
| 32 | 1 | 0 | 0 | 4 |
| 40 | 1 | 1 | 1 | 3 |
| 48 | 1 | 1 | 0 | 4 |
| 64 | 1 | 0 | 0 | 5 |

This gives the following results when evaluated using the CTC for VTM7.0: 0.00% (all intra) 0.00% (random access). Hence there is no longer any penalty compared to the original ALF. On the other hand, the gain of about 0.03% may not be enough to motivate the extra hardware needed.

1.5 Embodiments that Take Coefficient Statistics into Account

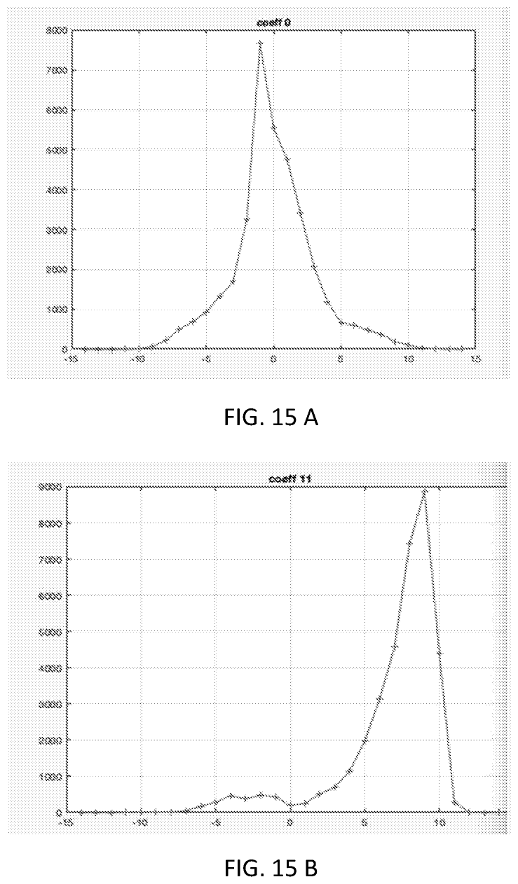

As described earlier, in the original VVC version of ALF, coefficients of smaller magnitudes are typically more common than coefficients of larger magnitudes. However, now that we have used a representation with increasing gaps between the allowed coefficient magnitudes, it may very well be the case that a value of 48 is as common as a value of 4. This is due to the fact that all values that are between 40 and 56 before quantization assume the value 48, whereas only values 4 and 5 may be quantized to 4. In FIG. 15A we give the results for the frequency distribution for coefficient C0 from embodiment 1.1. A shorthand is used for the different coefficient values described in Table 14.

TABLE 14

| sign + | | shorthand | |
|---|---|---|---|
| magnitude | shorthand | bits | sign bit |
| −128 | −14 | 1111 | 1 |
| −96 | −13 | 1110 | 1 |
| −64 | −12 | 1101 | 1 |
| −48 | −11 | 1100 | 1 |
| −32 | −10 | 1011 | 1 |
| −24 | −9 | 1010 | 1 |
| −16 | −8 | 1001 | 1 |
| −12 | −7 | 1000 | 1 |
| −8 | −6 | 0111 | 1 |
| −6 | −5 | 0110 | 1 |
| −4 | −4 | 0101 | 1 |
| −3 | −3 | 0100 | 1 |
| −2 | −2 | 0011 | 1 |
| −1 | −1 | 0010 | 1 |
| 0 | 0 | 000 | |
| 1 | 1 | 0010 | 0 |
| 2 | 2 | 0011 | 0 |
| 3 | 3 | 0100 | 0 |
| 4 | 4 | 0101 | 0 |
| 6 | 5 | 0110 | 0 |
| 8 | 6 | 0111 | 0 |
| 12 | 7 | 1000 | 0 |
| 16 | 8 | 1001 | 0 |
| 24 | 9 | 1010 | 0 |
| 32 | 10 | 1011 | 0 |
| 48 | 11 | 1100 | 0 |
| 64 | 12 | 1101 | 0 |
| 96 | 13 | 1110 | 0 |
| 128 | 14 | 1111 | 0 |

Plotting the values used for coefficient C0 in embodiment 1.1 gives the result shown in FIG. 15A. That is, FIG. 15A shows a frequency plot of different coefficient code values. Here −14 represents −128, −13 represents −96, . . . , 14 represents +128. Note that values −1 and 0 are the most common coefficients.

As can be seen in FIG. 15A, small magnitudes are still much more common than large ones for C0. However, this picture changes when looking at C11, which has the distribution shown in FIG. 15B. That is, FIG. 15B shows a frequency distribution of coefficient 11. Note that the most common shorthand value is +9, which corresponds to a coefficient value of +24. Other common values are +16 and +32.

Here it is seen that the most common coefficient values are 12, 16, 24 and 32. Even so the coefficient value that requires the fewest number of bits to code is still 0, which is rather uncommon for coefficient 11. It would be better if 24 (shorthand +9) would instead have the shortest codeword. That would be especially good if combined with the embodiment described in 1.2, since it has more codewords that are short. Hence in yet another embodiment, we subtract 9 from the shorthand before encoding it according to Table 15:

TABLE 15

| | Shorthand | Shorthand | Shorthand | sign |
|---|---|---|---|---|
| magnitude | before shift | after shift | bits | bit |
| −64 | −12 | 4 | 0111 | 0 |
| −48 | −11 | 5 | 1000 | 0 |
| −32 | −10 | 6 | 1001 | 0 |
| −24 | −9 | 7 | 1010 | 0 |
| −16 | −8 | 8 | 1011 | 0 |
| −12 | −7 | 9 | 1100 | 0 |
| −8 | −6 | 10 | 1101 | 0 |
| −6 | −5 | 11 | 1110 | 0 |
| −4 | −4 | 12 | 1111 | 0 |
| −3 | −3 | −12 | 1111 | 1 |
| −2 | −2 | −11 | 1110 | 1 |
| −1 | −1 | −10 | 1101 | 1 |
| 0 | 0 | −9 | 1100 | 1 |
| 1 | 1 | −8 | 1011 | 1 |
| 2 | 2 | −7 | 1010 | 1 |
| 3 | 3 | −6 | 1001 | 1 |
| 4 | 4 | −5 | 1000 | 1 |
| 6 | 5 | −4 | 0111 | 1 |
| 8 | 6 | −3 | 0110 | 1 |
| 12 | 7 | −2 | 010 | 1 |
| 16 | 8 | −1 | 001 | 1 |
| 24 | 9 | 0 | 000 | |
| 32 | 10 | 1 | 001 | 0 |
| 48 | 11 | 2 | 010 | 0 |
| 64 | 12 | 3 | 0110 | 0 |

Table 15 shows that shifting the shorthand makes it possible to assign shorter codewords to more likely coefficients, such as the value +24 for coefficient 11, which gets encoded using 3 bits.

As can be seen in the table 15, the value +32, which is very common for coefficient 11, first gets assigned shorthand value 10. However, this value is shifted by subtracting 9 (the most common value for C11), using modulus calculation:

shifted shorthand=(((shorthand+12)−9)mod 25)−12. (Eqn 10)

For the shorthand value 10, this becomes ((10+12−9)mod 25)−12=(13 mod 25)−12=1. This shorthand value is encoded as 001 0, which is only four bits. The modulus calculation is used to avoid values outside the range [−12,12].

Since the statistics differ between different coefficients, it is best to subtract a different value depending upon which coefficient we are encoding. Hence one may use:

shifted shorthand=(((shorthand+12)−offsetₖ)mod 25)−12, (Eqn 11)

where k depends on which coefficient we are encoding (k=0 for C0 etc) and offsetₖ={0, 0, 6, −1, 0, −5, 7, 8, 7, 0, −6, 8}. This gave the following results when evaluated using the CTC for VTM6.0: 0.01% (all intra) 0.02% (random access) −0.03% (low delay B) 0.01% (low-delay P)

For the chroma components, the current version of ALF only uses 6 coefficients. Hence the best shift value to use is different between luma and chroma. As an example one can use the following shift values for the chroma coefficients: {−5, 8, 9, 8, −6, 8}. One then gets the following (luma) BD-rate results using the CTC for VTM6.0: 0.00% (all intra) 0.01% (random access) −0.03% (low-delay B) 0.00% (low-delay P). This has completely eliminated the penalty for all intra, low-delay B and low-delay P and has only a small penalty for random access.

1.6 Embodiments where Coefficients are not Encoded Using Magnitude Plus Sign

The ALF coefficient coding from embodiment 1.1 to embodiment 1.3 codes the coefficient magnitude (or magnitude index) and the coefficient sign separately. Here, the coefficient which has a magnitude of 0 is coded with shorter code (fewer bits) compared to a coefficient which has a magnitude that is larger than 0. Considering the coefficient statistic in embodiment 1.3, there is another way to code the ALF coefficient more efficiently by coding the index of the signed magnitude.

The index (shorthand) of the signed magnitude before shift ranges from 0, 1, . . . to 24, which represents the signed magnitude {0, 1, 2, . . . , 48, 64, −64, −48, . . . , −2, −1}. The index ranges from 0, 1, . . . to 24 are coded by truncated binary code with a maximum symbol of 25.

TABLE 16

| | | shorthand |
|---|---|---|
| value | Shorthand | bits |
| 0 | 0 | 0000 |
| 1 | 1 | 0001 |
| 2 | 2 | 0010 |
| 3 | 3 | 0011 |
| 4 | 4 | 0100 |
| 6 | 5 | 0101 |
| 8 | 6 | 0110 |
| 12 | 7 | 01110 |
| 16 | 8 | 01111 |
| 24 | 9 | 10000 |
| 32 | 10 | 10001 |
| 48 | 11 | 10010 |
| 64 | 12 | 10011 |
| −64 | 13 | 10100 |
| −48 | 14 | 10101 |
| −32 | 15 | 10110 |
| −24 | 16 | 10111 |
| −16 | 17 | 11000 |
| −12 | 18 | 11001 |
| −8 | 19 | 11010 |
| −6 | 20 | 11011 |
| −4 | 21 | 11100 |
| −3 | 22 | 11101 |
| −2 | 23 | 11110 |
| −1 | 24 | 11111 |

Compared to the ALF coefficient coding methods in 1.2, where only one ALF coefficient is coded by 3 bits, four ALF coefficients are coded by 4 bits and 20 ALF coefficients are coded by 5 bits, the coding method above has seven ALF coefficients that are coded by 4 bits and 18 ALF coefficients that are coded by 5 bits.

Considering the shorthand shift as described in embodiment 1.3, the fewest number of shorthand bits are assigned to the most frequent used ALF coefficients. One example of coding for luma ALF coefficient 11 is shown in table 17:

TABLE 17

| | Shorthand | Shorthand | shorthand |
|---|---|---|---|
| Value | Before shift | After shift | bits |
| 0 | 0 | 21 | 0000 |
| 1 | 1 | 22 | 0001 |
| 2 | 2 | 23 | 0010 |
| 3 | 3 | 24 | 0011 |
| 4 | 4 | 0 | 0100 |
| 6 | 5 | 1 | 0101 |
| 8 | 6 | 2 | 0110 |
| 12 | 7 | 3 | 01110 |
| 16 | 8 | 4 | 01111 |
| 24 | 9 | 5 | 10000 |
| 32 | 10 | 6 | 10001 |
| 48 | 11 | 7 | 10010 |
| 64 | 12 | 8 | 10011 |
| −1 | 13 | 9 | 10100 |
| −2 | 14 | 10 | 10101 |
| −3 | 15 | 11 | 10110 |
| −4 | 16 | 12 | 10111 |
| −6 | 17 | 13 | 11000 |
| −8 | 18 | 14 | 11001 |
| −12 | 19 | 15 | 11010 |
| −16 | 20 | 16 | 11011 |
| −24 | 21 | 17 | 11100 |
| −32 | 22 | 18 | 11101 |
| −48 | 23 | 19 | 11110 |
| −64 | 24 | 20 | 11111 |

In the above examples, the short hand shift value is 4. To derive the shorthand value before shift, we add the shift value to the shorthand after shift and modulus by 25.

One example that we use the shift value as following for 12 luma ALF coefficients and 6 chroma ALF coefficients:

TABLE 18

| | Coeff | Coeff | Coeff | Coeff | Coeff | Coeff | Coeff | Coeff | Coeff | Coeff | Coeff | Coeff |
|---|---|---|---|---|---|---|---|---|---|---|---|---|
| | 0 | 1 | 2 | 3 | 4 | 5 | 6 | 7 | 8 | 9 | 10 | 11 |
| Luma | −3 | −2 | 2 | −6 | −5 | −7 | 3 | 4 | 3 | −2 | −7 | 4 |
| Chroma | −7 | 4 | 4 | 4 | −7 | 5 | | | | | | |

This gives the following results when evaluated using the CTC for VTM6.0: 0.01% (all intra) 0.00% (random access) −0.06% (low delay B).

1.7 Embodiments where coefficients belong to set Z are used as ALF filter coefficients

In this embodiment, the ALF filter coefficients belong to set Z=−127, −126, −124, −120, −112, −96, −80, −72, −68, −66, −65, −64, −63, −62, −60, −56, −48, −40, −36, −34, −33, −32, −31, −30, −28, −24, −20, −18, −17, −16, −15, −14, −12, −10, −9, −8, −7, −6, −5, −4, −3, −2, −1, 0, 1, 2, 3, 4, 5, 6, 7, 8, 9, 10, 12, 14, 15, 16, 17, 18, 20, 24, 28, 30, 31, 32, 33, 34, 36, 40, 48, 56, 60, 62, 63, 64, 65, 66, 68, 72, 80, 96, 112, 120, 124, 126, 127,}. The APS ALF coefficients coding is same as VTM7.0, as: a) 3-order Exponential-Golomb coding for coefficients magnitude; b) 1 bit coefficient sign coding if the coefficient is not equal to 0.

A multiplication a*b where a belongs to set Z can be written as

a*b=(−1)ⁿ(((b&_{b}k₁)<<s₀)+(−1)^{c}(b&_{b}k₀))2^{s}^{₁}. (Eqn 12)

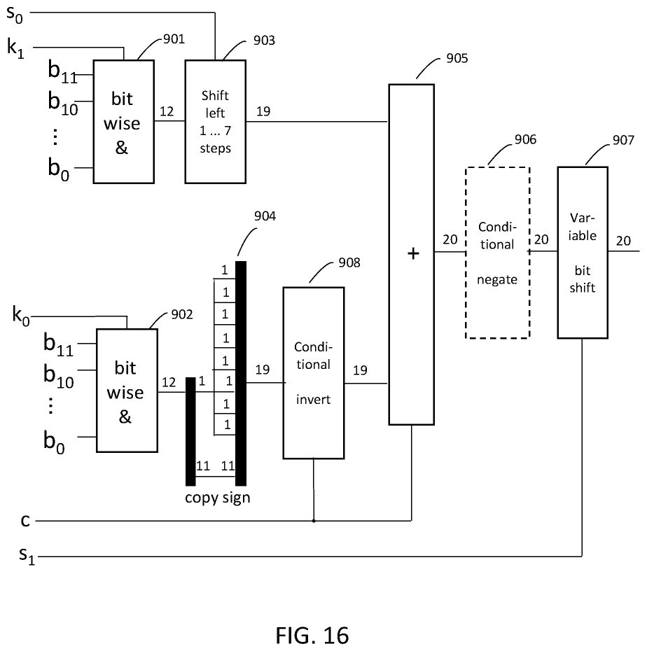

As an example, 62*b can be written as: (−1)⁰(((b &_{b} 1)<<5)+(−1)¹(b &_{b}1))2¹ since that evaluates to ((b<<5)−b)2¹=(32b−b)*2=31b*2=62b. Equation 12 can be inexpensively be implemented using the hardware depicted in FIG. 16.

Compared to FIG. 13, there are two major differences. The unit 903 (compare to 803 in FIG. 13) can now shift between 1 and 7 steps to the left, instead of just 1 or 2 steps. Furthermore, there is a new box in 908. This box inverts all bits if c=1, otherwise it just passes them through. This can be inexpensively implemented by XORing with c, just as is done in the left part of FIG. 11. Furthermore the bit c is used as carry in to the adder 905. Together with the conditional inverter 908, this has the effect of negating the expression (b &_{b} k₀) if c=1, and hence implements (−1)^{c}(b &_{b} k₀) from Equation 12.

This gives the following results when evaluated using the CTC for VTM7.0: 0.01% (all intra) 0.01% (random access).

1.8 Embodiments where Coefficients Belong to a Subset of Z are Used as ALF Filter Coefficients

In all previous embodiments, the ALF filter coefficients belong to a subset of Z.

One example in this embodiment, the ALF filter coefficients belong to set Z_{sub}={−40, −33, −28, −24, −20, −17, −15, −14, −12, −10, −9, −8, −7, −6, −5, −4, −3, −2, −1, 0, 1, 2, 3, 4, 5, 6, 7, 8, 9, 10, 12, 14, 15, 17, 20, 24, 28, 33, 40}. The APS ALF coefficients coding uses the truncated binary coding to code the index of the coefficient magnitude and 1-bit coefficient sign coding if the coefficient is not equal to 0:

TABLE 19

| magnitude | index | index bits | sign bit |
|---|---|---|---|
| | 0 | 0000 | |
| | 1 | 0001 | 0/1 |
| | 2 | 0010 | 0/1 |
| | 3 | 0011 | 0/1 |
| | 4 | 0100 | 0/1 |
| | 5 | 0101 | 0/1 |
| | 6 | 0110 | 0/1 |
| | 7 | 0111 | 0/1 |
| | 8 | 1000 | 0/1 |
| | 9 | 1001 | 0/1 |
| | 10 | 1010 | 0/1 |
| | 11 | 1011 | 0/1 |
| | 12 | 11000 | 0/1 |
| | 13 | 11001 | 0/1 |
| | 14 | 11010 | 0/1 |
| | 15 | 11011 | 0/1 |
| | 16 | 11100 | 0/1 |
| | 17 | 11101 | 0/1 |
| | 18 | 11110 | 0/1 |
| | 19 | 11111 | 0/1 |

Since Z_{sub} is a subset of Z, it is possible to use the hardware implementation in FIG. 16 to implement the multiplications. The variables k₁, k₀, s₀, s₁, c and n can be obtained using look-up from Table 20. Note that this can take place at the time of decoding the transform coefficients and hence only needs to happen once per CTU, not once per sample.

TABLE 20
(Values that can be used for k_1, k_0, s_0, s_1
c and n when the coefficient belongs to Z_sub.)

| coefficient | k_1 | k_0 | s_0 | s_1 | c | n |
|---|---|---|---|---|---|---|
| −40 | 1 | 1 | 1 | 3 | 0 | 1 |
| −33 | 1 | 1 | 4 | 0 | 0 | 1 |
| −28 | 1 | 1 | 2 | 2 | 1 | 1 |
| −24 | 1 | 1 | 0 | 3 | 0 | 1 |
| −20 | 1 | 1 | 1 | 2 | 0 | 1 |
| −17 | 1 | 1 | 3 | 0 | 0 | 1 |
| −15 | 1 | 1 | 3 | 0 | 1 | 1 |
| −14 | 1 | 1 | 2 | 1 | 1 | 1 |
| −12 | 1 | 1 | 0 | 2 | 0 | 1 |
| −10 | 1 | 1 | 1 | 1 | 0 | 1 |
| −9 | 1 | 1 | 1 | 1 | 1 | 1 |
| −8 | 1 | 0 | 1 | 1 | 0 | 1 |
| −7 | 1 | 1 | 2 | 0 | 1 | 1 |
| −6 | 1 | 1 | 0 | 1 | 0 | 1 |
| −5 | 1 | 1 | 1 | 0 | 0 | 1 |
| −4 | 1 | 0 | 1 | 0 | 0 | 1 |
| −3 | 1 | 1 | 0 | 0 | 0 | 1 |
| −2 | 1 | 0 | 0 | 0 | 0 | 1 |
| −1 | 0 | 1 | 0 | 0 | 0 | 1 |
| 0 | 0 | 0 | 0 | 0 | 0 | 0 |
| 1 | 0 | 1 | 0 | 0 | 0 | 0 |
| 2 | 1 | 0 | 0 | 0 | 0 | 0 |
| 3 | 1 | 1 | 0 | 0 | 0 | 0 |
| 4 | 1 | 0 | 1 | 0 | 0 | 0 |
| 5 | 1 | 1 | 1 | 0 | 0 | 0 |
| 6 | 1 | 1 | 0 | 1 | 0 | 0 |
| 7 | 1 | 1 | 2 | 0 | 1 | 0 |
| 8 | 1 | 0 | 1 | 1 | 0 | 0 |
| 9 | 1 | 1 | 1 | 1 | 1 | 0 |
| 10 | 1 | 1 | 1 | 1 | 0 | 0 |
| 12 | 1 | 1 | 0 | 2 | 0 | 0 |
| 14 | 1 | 1 | 2 | 1 | 1 | 0 |
| 15 | 1 | 1 | 3 | 0 | 1 | 0 |
| 17 | 1 | 1 | 3 | 0 | 0 | 0 |
| 20 | 1 | 1 | 1 | 2 | 0 | 0 |
| 24 | 1 | 1 | 0 | 3 | 0 | 0 |
| 28 | 1 | 1 | 2 | 2 | 1 | 0 |
| 33 | 1 | 1 | 4 | 0 | 0 | 0 |
| 40 | 1 | 1 | 1 | 3 | 0 | 0 |

This gives the following results when evaluated using the CTC for VTM7.0: −0.01% (all intra) −0.01% (random access).

1.9 Embodiments that Treat Coefficients Differently

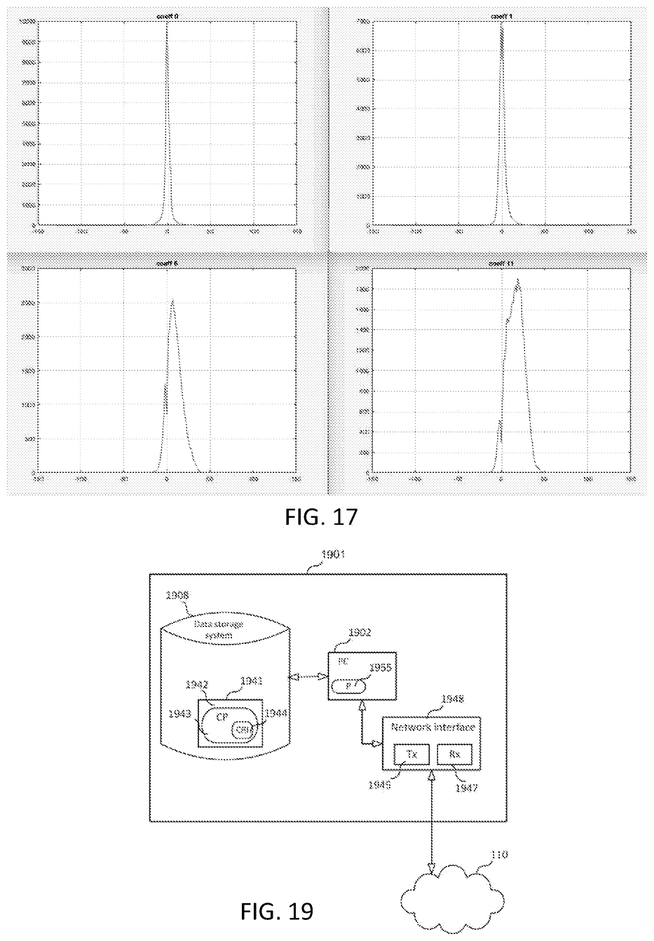

In FIG. 15A the frequencies of different coefficient sizes for an embodiment that already has restricted the coefficients to belong to the set S is plotted. It is also possible to plot the frequencies for the non-altered code in VTM-6.0, where the coefficients are allowed all values between [−127, 127], i.e., they belong to the set T. FIG. 17 shows the values of coefficient C0, C1, C6 and C11 respectively. FIG. 17: Two of the coefficients that are far away from the center are C0 and C1 (top), and they have a rather different statistics than the two coefficients closest to the center, C6 and C11 (bottom).

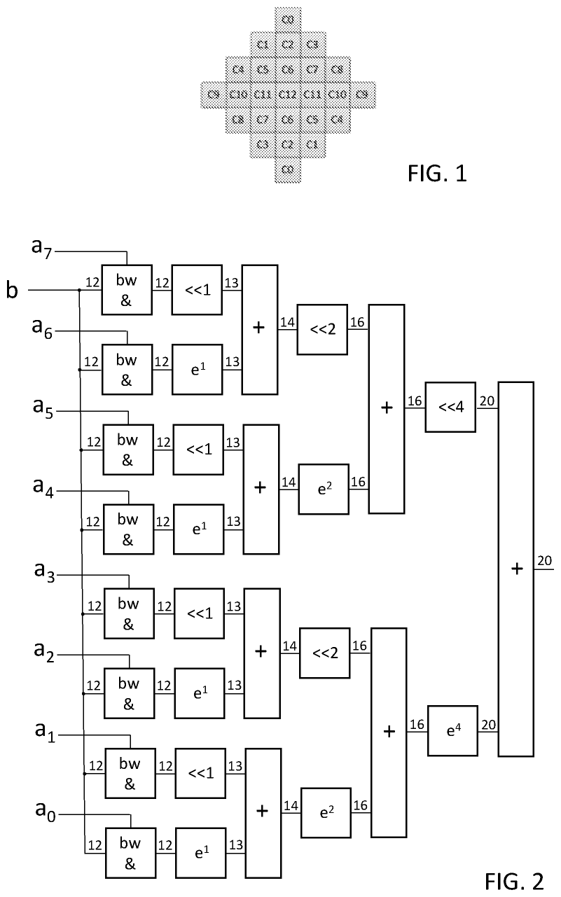

The coefficients C0 and C1, whose frequency plots are depicted in the top half of FIG. 17, are far away from the center sample, as can be seen in FIG. 1.

Note that their statistics is quite different from the statistics of C6 and C11 (bottom part of FIG. 17), which are the closest ones to the center sample. Two things stand out: First, whereas C0 and C1 are clustered around the value 0, C6 has its peak at C6=+7 and C11 has it peak at C11=+20. Second—the distributions of C6 and C11 are much flatter than for C0 and C1—the peak goes up to around 2000 compared to over 7000 for C0 and C1.

The first fact, that the average value of C6 and C11 are larger than 0, means that the most common values will be heavily quantized. As an example, if we can only represent coefficient C11 with a value from S₆₄={0, +1, +2, +3, +4, +6, +8, +12, +16, +24, +32, +48, +64}, we cannot reach the most common value 20. This means that we have to choose between too weak a filtering using C11=16 or too strong a filtering using C11=24.

The second fact, i.e., that the distributions of C6 and C11 are flatter than for the other coefficients, means that higher values are more common in general. Unfortunately, if we can only represent these coefficients with values from the set S₆₄, this means that the error will on average be larger for C6 and C11 than for C0 and C1. As an example, if C0 would never go beyond [−4,4], there would be no error compared to the VTM-6.0 version, since all values between [−4,4] are available in S₆₄. For C6 and C11 the opposite is true—these coefficients are almost never near the zero-error region of [−4,4]. Hence forcing C6 and C11 to be a value in S₆₄ will contribute much more to the error than forcing C0 and C1 to belong to S₆₄.

Therefore, in one embodiment of the present invention, C6 and C11 are allowed to assume any value in T, i.e., any value in [−127,127]. All the other coefficients, i.e., C0-C5 and C7-C10 will have to take a value a restricted subset of T, such as S₆₄. This means that for a hardware implementation, the hardware circuit handling the multiplication by C6 and C11 may be different from the hardware circuit handling the multiplication by C0-C5 and C7-C10. Hence, instead of replacing all 12 multiplications in Equation 1 with inexpensive addition-based hardware such as that depicted in FIG. 8, only 10 of these multiplications can be replaced. The remaining two multiplications, i.e., for C6 and C11, will have to be full multiplications capable of multiplying by any number in T. Implementing this in VTM-7.0 will give the following BDR figures: +0.01% (AI) and +0.02% (RA).

In another embodiment, only C11 will use a full multiplication, whereas C0-C10 (i.e., including C6) will use restricted multiplication capable of only a subset such as S₆₄.

In one embodiment, C6 and C11 can take any number in T whereas C0-C5 and C7-C10 will be restricted to S_{POT}={0, +1, +2, +4, +8, +16, ±32, ±64, ±128}, i.e., only numbers that are either zero or can be written as a power of two. Implementing this in VTM-7.0 will give the following BDR figures: +0.07% (AI) and +0.10% (RA).

In yet another embodiment, C6 and C11 can take a number in a restricted set such as S₆₄ whereas C0-C5 and C7-C10 can take a number in an even more restricted set such as S_{POT}.

1.10 Embodiments that Use an Average Value

In another embodiment, instead of representing values close to 0 with a higher accuracy, values close to the average value for C6 and C11 are represented with a higher accuracy.

As an example, take again Equation 1 and assume all coefficients except for C11 are zero. Then:

sum=C11*[clip(s11,R(x−1,y)−R(x,y))+clip(s11,R(x+1,y)−R(x,y))], (Eqn 17)

and by letting b be the expression in square brackets, one gets:

sum=C11*b (Eqn 18)

As described above, in embodiments the value C11 is constrained to be in a certain set, such as S₆₄, while allowing b to take any value. However, assume that one uses C11=16+Δ₁₁, and that it is Δ₁₁ that is signaled instead of C11. This means that one can write Equation 18 as

$$sum = ( 16 + {Δ}_{11} ) * b = 16 * b + {Δ}_{11} * b = ( b ≪ 4 ) + {Δ}_{11} * b . \qquad ( Eqn 19 )$$

Now, if Δ₁₁ is restricted to S₆₄, one can use the inexpensive hardware in FIG. 8 to calculate Δ₁₁*b. One must then add (b<<4) to get the correct term, and that requires another addition, which is expensive. However, even when adding the cost of this extra addition to the hardware in FIG. 8, the total cost is still much less than a general multiplication.

Forcing C11 to be 16+Δₙ is equivalent to forcing C11 to be in the subset S₆₄₊₁₆={−48, −32, −16, −8, 0, 4, 8, 10, 12, 13, 14, 15, 16, 17, 18, 19, 20, 22, 24, 28, 32, 40, 48, 64, 80}. Since this subset contains many more values close to 20 than does S₆₄, the average error induced by forcing C11 to S₆₄₊₁₆ will be much smaller than the average error induced by forcing C11 to S₆₄.

Similarly, C6 may be set to 8+Δ8, which can be implemented similarly inexpensively. By implementing this approach for C6 and C11 in VTM-7.0 it is possible to reach the following BDR figures: +0.01% (AI) and +0.06% (RA). In one solution, every coefficient Cx is set to i+Δₓ where we have a bias value i that is either a power-of-two±2^{nx} (positive or negative) or zero. In other implementations, it may be sufficient to have some of these bias values being non-zero.

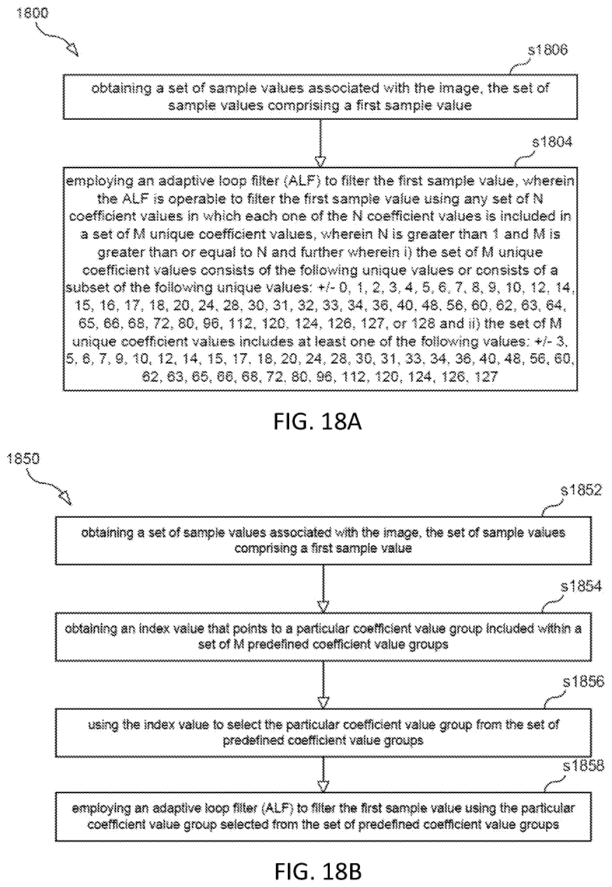

FIG. 18A is a flow chart illustrating a process 1800, according to one embodiment, for decoding an image. Process 1800 may begin in steps s1802.

Step s1802 comprises obtaining a set of sample values associated with the image, the set of sample values comprising a first sample value.

Step s1804 comprises employing an adaptive loop filter (ALF) to filter the first sample value, wherein the ALF is operable to filter the first sample value using any set of N coefficient values in which each one of the N coefficient values is included in a set of M unique coefficient values, wherein N is greater than 1 and M is greater than or equal to N and further wherein i) the set of M unique coefficient values consists of the following unique values or consists of a subset of the following unique values: +/−0, 1, 2, 3, 4, 5, 6, 7, 8, 9, 10, 12, 14, 15, 16, 17, 18, 20, 24, 28, 30, 31, 32, 33, 34, 36, 40, 48, 56, 60, 62, 63, 64, 65, 66, 68, 72, 80, 96, 112, 120, 124, 126, 127, or 128 (i.e., Z+128) and ii) the set of M unique coefficient values includes at least one of the following values: +/−3, 5, 6, 7, 9, 10, 12, 14, 15, 17, 18, 20, 24, 28, 30, 31, 33, 34, 36, 40, 48, 56, 60, 62, 63, 65, 66, 68, 72, 80, 96, 112, 120, 124, 126, 127.

Employing the ALF to filter the first sample value comprises the steps of: a) obtaining a first set of N coefficient values for use in filtering the first sample value and b) using the ALF to filter the first sample value using the obtained first set of N coefficient values and the set of sample values, thereby producing a first filtered sample value, and each coefficient value included in the obtained first set of N coefficient values is constrained such that the coefficient value must be equal to one of the values included in the set of M unique values.

In one embodiment, the set of M unique coefficient values consists of the following unique values: +/−0, 1, 2, 3, 4, 6, 8, 12, 16, 24, 32, 48, or 64 (i.e., S₆₄).

In another embodiment, the set of M unique coefficient values consists of the following unique values: +/−0, 1, 2, 3, 4, 6, 8, 12, 16, 24, 32, 48, 64, or 96 (i.e., S₉₆).

In another embodiment, the set of M unique coefficient values consists of the following unique values: +/−0, 1, 2, 3, 4, 6, 8, 12, 16, 24, 32, 48, 64, 96, or 127 (i.e., S₁₂₇).

In another embodiment, the set of M unique coefficient values consists of the following unique values: +/−0, 1, 2, 3, 4, 5, 6, 8, 10, 12, 16, 20, 24, 32, 40, 48, or 64 (i.e., S₁₃₅).

In another embodiment, the set of M unique coefficient values consists of the following unique values: +/−0, 1, 2, 3, 4, 6, 8, 12, 16, 24, 32, 48, 64, 96, or 128 (i.e., S).

In another embodiment, the set of M unique coefficient values consists of the following unique values: +/−0, 1, 2, 3, 4, 5, 6, 7, 8, 9, 10, 12, 14, 15, 17, 20, 24, 28, 33, or 40 (i.e., Zsub).

FIG. 18B is a flow chart illustrating a process 1850, according to one embodiment, for decoding an image. Process 1850 may begin in steps s1852.

Step s1852 comprises obtaining a set of sample values associated with the image, the set of sample values comprising a first sample value.

Step s1854 comprises obtaining an index value that points to a particular coefficient value group included within a set of M predefined coefficient value groups (e.g., M=64). Each coefficient value group included in the set of predefined coefficient value groups consists of N coefficient values, N being greater than 1. For each coefficient value group included in the set of predefined coefficient value groups, each coefficient value included in the coefficient group is constrained such that the coefficient value must be equal to one of the following values: +/−0, 1, 2, 3, 4, 5, 6, 7, 8, 9, 10, 12, 14, 15, 16, 17, 18, 20, 24, 28, 30, 31, 32, 33, 34, 36, 40, 48, 56, 60, 62, 63, 64, 65, 66, 68, 72, 80, 96, 112, 120, 124, 126, 127, or 128 (i.e., Z+128). Also, for at least one coefficient value group included in the set of predefined coefficient value groups, at least one of the coefficient values included in said at least one coefficient value group is equal to one of the following values: +/−3, 5, 6, 7, 9, 10, 12, 14, 15, 17, 18, 20, 24, 28, 30, 31, 33, 34, 36, 40, 48, 56, 60, 62, 63, 65, 66, 68, 72, 80, 96, 112, 120, 124, 126, or 127.

Step s1856 comprises using the index value to select the particular coefficient value group from the set of predefined coefficient value groups.

Step s1858 comprises employing an adaptive loop filter (ALF) to filter the first sample value using the particular coefficient value group selected from the set of predefined coefficient value groups.

FIG. 20 is a flow chart illustrating a process 2000, according to one embodiment, that is performed by encoder 302. Process 2000 may begin in steps s2002.

Step s2002 comprises the encoder selecting a set of coefficient values for use by a decoder in filtering a sample value, the selected set of coefficient values consisting of N coefficient values. Each one of the N coefficient values is included in a set of M unique coefficient values, wherein N is greater than 1 and M is greater than 1 and further wherein i) the set of M unique coefficient values consists of the following unique values or consists of a subset of the following unique values: +/−0, 1, 2, 3, 4, 5, 6, 7, 8, 9, 10, 12, 14, 15, 16, 17, 18, 20, 24, 28, 30, 31, 32, 33, 34, 36, 40, 48, 56, 60, 62, 63, 64, 65, 66, 68, 72, 80, 96, 112, 120, 124, 126, 127, or 128 (i.e., Z+128) and ii) the set of M unique coefficient values includes at least one of the following values: +/−3, 5, 6, 7, 9, 10, 12, 14, 15, 17, 18, 20, 24, 28, 30, 31, 33, 34, 36, 40, 48, 56, 60, 62, 63, 65, 66, 68, 72, 80, 96, 112, 120, 124, 126, or 127, and each coefficient value included in the set of N coefficient values is constrained such that the coefficient value must be equal to one of the values included in the set of M unique values.

Step s2004 comprises the encoder providing to a decoder (304) the N coefficient values or an initial index value for use by the encoder to determine the set of N coefficient values.

In some embodiment process 2000 also includes the step of determining a class to which the first sample value belongs, and the step of obtaining the index value comprises obtaining the index value using an initial index value signaled by an encoder and information identifying the determined class. For example, the initial index value may point to a particular set of N index values, where each one of the N index values is associated with a different class, and the decoder obtains the index value by obtaining the index value from the set of N index value that is associated with the determined class.

FIG. 19 is a block diagram of an apparatus 1901 for implementing encoder 302 or decoder 304, according to some embodiments. That is, apparatus 1901 can be configured to perform the methods disclosed herein. In embodiments where apparatus 1901 implements encoder 302, apparatus 1901 may be referred to as “encoding apparatus 1901,” and in embodiments where apparatus 1901 implements decoder 304, apparatus 1901 may be referred to as a “decoding apparatus 1901.” As shown in FIG. 19, apparatus 1901 may comprise: processing circuitry (PC) 1902, which may include one or more processors (P) 1955 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed; one or more network interfaces 1948 (which may be co-located or geographically distributed) where each network interface includes a transmitter (Tx) 1945 and a receiver (Rx) 1947 for enabling apparatus 1901 to transmit data to and receive data from other nodes connected to network 110 (e.g., an Internet Protocol (IP) network) to which network interface 1948 is connected; and one or more storage units (a.k.a., “data storage systems”) 1908 which may be co-located or geographically distributed and which may include one or more non-volatile storage devices and/or one or more volatile storage devices. In embodiments where PC 1902 includes a programmable processor, a computer program product (CPP) 1941 may be provided. CPP 1941 includes a computer readable medium (CRM) 1942 storing a computer program (CP) 1943 comprising computer readable instructions (CRI) 1944. CRM 1942 may be a non-transitory computer readable medium, such as, magnetic media (e.g., a hard disk), optical media, memory devices (e.g., random access memory, flash memory), and the like. In some embodiments, the CRI 1944 of computer program 1943 is configured such that when executed by PC 1902, the CRI causes apparatus 1901 to perform steps described herein (e.g., steps described herein with reference to the flow charts). In other embodiments, apparatus 1901 may be configured to perform steps described herein without the need for code. That is, for example, PC 1902 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for decoding an image, the method comprising:
obtaining a set of sample values associated with the image, the set of sample values comprising a first sample value; and
employing an adaptive loop filter (ALF) to filter the first sample value, wherein the ALF is operable to filter the first sample value using any set of N coefficient values in which each one of the N coefficient values is included in a set of M unique coefficient values, wherein N is greater than 1 and M is greater than 1 and further wherein i) the set of M unique coefficient values consists of the following unique values or consists of a subset of the following unique values: +/−0, 1, 2, 3, 4, 5, 6, 7, 8, 9, 10, 12, 14, 15, 16, 17, 18, 20, 24, 28, 30, 31, 32, 33, 34, 36, 40, 48, 56, 60, 62, 63, 64, 65, 66, 68, 72, 80, 96, 112, 120, 124, 126, 127, or 128 and ii) the set of M unique coefficient values includes at least one of the following values: +/−3, 5, 6, 7, 9, 10, 12, 14, 15, 17, 18, 20, 24, 28, 30, 31, 33, 34, 36, 40, 48, 56, 60, 62, 63, 65, 66, 68, 72, 80, 96, 112, 120, 124, 126, or 127, wherein
employing the ALF to filter the first sample value comprises the steps of: a) obtaining a first set of N coefficient values for use in filtering the first sample value and b) using the ALF to filter the first sample value using the obtained first set of N coefficient values and the set of sample values, thereby producing a first filtered sample value, and
each coefficient value included in the obtained first set of N coefficient values is constrained such that the coefficient value must be equal to one of the values included in the set of M unique values.

2. The method of claim 1, wherein the set of M unique coefficient values consists of the following unique values: +/−0, 1, 2, 3, 4, 6, 8, 12, 16, 24, 32, 48, or 64.

3. The method of claim 1, wherein the set of M unique coefficient values consists of the following unique values: +/−0, 1, 2, 3, 4, 6, 8, 12, 16, 24, 32, 48, 64, or 96.

4. The method of claim 1, wherein the set of M unique coefficient values consists of the following unique values: +/−0, 1, 2, 3, 4, 6, 8, 12, 16, 24, 32, 48, 64, 96, or 127.

5. The method of claim 1, wherein the set of M unique coefficient values consists of the following unique values: +/−0, 1, 2, 3, 4, 5, 6, 8, 10, 12, 16, 20, 24, 32, 40, 48, or 64.

6. The method of claim 1, wherein the set of M unique coefficient values consists of the following unique values: +/−0, 1, 2, 3, 4, 6, 8, 12, 16, 24, 32, 48, 64, 96, or 128.

7. The method of claim 1, wherein the set of M unique coefficient values consists of the following unique values: +/−0, 1, 2, 3, 4, 5, 6, 7, 8, 9, 10, 12, 14, 15, 17, 20, 24, 28, 33, or 40.

8. A method for decoding an image, the method comprising:
obtaining a set of sample values associated with the image, the set of sample values comprising a first sample value;
obtaining an index value that points to a particular coefficient value group included within a set of M predefined coefficient value groups, wherein each coefficient value group included in the set of predefined coefficient value groups consists of N coefficient values, N being greater than 1, and further wherein: i) for each coefficient value group included in the set of predefined coefficient value groups, each coefficient value included in the coefficient group is constrained such that the coefficient value must be equal to one of the following values: +/−0, 1, 2, 3, 4, 5, 6, 7, 8, 9, 10, 12, 14, 15, 16, 17, 18, 20, 24, 28, 30, 31, 32, 33, 34, 36, 40, 48, 56, 60, 62, 63, 64, 65, 66, 68, 72, 80, 96, 112, 120, 124, 126, 127, or 128 and ii) for at least one coefficient value group included in the set of predefined coefficient value groups, at least one of the coefficient values included in said at least one coefficient value group is equal to one of the following values: +/−3, 5, 6, 7, 9, 10, 12, 14, 15, 17, 18, 20, 24, 28, 30, 31, 33, 34, 36, 40, 48, 56, 60, 62, 63, 65, 66, 68, 72, 80, 96, 112, 120, 124, 126, or 127;
using the index value to select the particular coefficient value group from the set of predefined coefficient value groups; and
employing an adaptive loop filter (ALF) to filter the first sample value using the particular coefficient value group selected from the set of predefined coefficient value groups.

9. The method of claim 8, wherein
the method further comprises determining a class to which the first sample value belongs, and
the step of obtaining the index value comprises obtaining the index value using an initial index value signaled by an encoder and information identifying the determined class.

10. A decoding apparatus, the decoding apparatus being adapted to perform the method of claim 1.

11. A method performed by an encoder, the method comprising:
the encoder selecting a set of coefficient values for use by a decoder in filtering a sample value, the selected set of coefficient values consisting of N coefficient values;
the encoder providing to a decoder the N coefficient values or an initial index value for use by the encoder to determine the set of N coefficient values, wherein
each one of the N coefficient values is included in a set of M unique coefficient values, wherein N is greater than 1 and M is greater than 1 and further wherein i) the set of M unique coefficient values consists of the following unique values or consists of a subset of the following unique values: +/−0, 1, 2, 3, 4, 5, 6, 7, 8, 9, 10, 12, 14, 15, 16, 17, 18, 20, 24, 28, 30, 31, 32, 33, 34, 36, 40, 48, 56, 60, 62, 63, 64, 65, 66, 68, 72, 80, 96, 112, 120, 124, 126, 127, or 128 and ii) the set of M unique coefficient values includes at least one of the following values: +/−3, 5, 6, 7, 9, 10, 12, 14, 15, 17, 18, 20, 24, 28, 30, 31, 33, 34, 36, 40, 48, 56, 60, 62, 63, 65, 66, 68, 72, 80, 96, 112, 120, 124, 126, or 127, and
each coefficient value included in the set of N coefficient values is constrained such that the coefficient value must be equal to one of the values included in the set of M unique values.

12. An encoding apparatus, the encoding apparatus being adapted to perform the method of claim 11.

13. A non-transitory computer readable medium storing a computer program comprising instructions which when executed by processing circuitry causes the processing circuitry to perform the method of claim 1.

14. A non-transitory computer readable medium storing a computer program comprising instructions which when executed by processing circuitry causes the processing circuitry to perform the method of claim 8.

15. A non-transitory computer readable medium storing a computer program comprising instructions which when executed by processing circuitry causes the processing circuitry to perform the method of claim 11.

16. A decoding apparatus, the decoding apparatus being adapted to perform the method of claim 8.
